(19) United States
(12) Patent Application Publication
(10) Pub. No.: US 2010/0191615 A1
(43) Pub. Date: Jul. 29, 2010

(54) Shipping and Storage Containers, Frames, and Carriages, for Franchise Systems for Rental, Lease, Sale, or Licensing, of Businesses and Components including Standardized Lengths, Heights, Widths, and Sizes, of Containers with or without Interchangeable Carriages for Rail Cars, Semi-Tractor Trailers and Overseas Cargo Containers including Six Piece Break Down and Stack and Rolling and Opening Door Models also New Storage Yard Business Transportation Connections, Combinations, and Usages

(76) Inventor: Michael Robert Thomas, N. Ft. Myers, FL (US)

Correspondence Address: MICHAEL R. THOMAS INVENTING CONSULANT, 189 Evergreen Rd., NORTH FORT MYERS, FL, 33903, US

(21) Appl. No.: 12/696,609

(22) Filed: Jan. 29, 2010

Related U.S. Application Data
(60) Provisional application No. 61/148,135, filed on Jan. 29, 2009.

(51) Int. Cl. G06Q 30/00; B61D 3/00; B65D 88/00; B61B 1/00; A47G 29/00; E04H 5/02

(52) U.S. Cl. 705/26; 105/355; 220/1.5; 104/26.1; 211/71.01; 52/27; 705/330

(57) ABSTRACT

The new system of components involves improved efficiency of business operations for railroad, semi-tractor trailer, and shipping and storage containers. The new divided compartment multiple subunit rolling or knob door climate controlled shipping and storage cars, break down containers, and light weight aluminum containers and cars interconnect manufacturer's facilities with staging warehouses with storage, and transportation yards and retail/wholesale manufacturers and service related businesses. Stacked interchangeable components allow quick erection for immediate demand unit usage and quick conversion from railroad to highway mode without unloading of standardized cubicle containers and cars to improve operating efficiency. The new usages and locations of hook holes for lifting components allows car and frame usage in locations with crane or forklift availability. The new storage units allow for small or larger load transportation at lower cost.

### DRAWINGS AND SPECIFICATIONS

FIG. 1 Side View of 3 Different Aluminum or Steel Permanently Constructed Container Cars with Rolling or Knob Opening Doors with Wide Forklift Holes, for Cargo Shipping or Storage Container, carried by Semi-Trailer, Rail Car, or Ocean Cargo Ship Container Units, for use with Paletted Containers or Loose Storage Goods, with Double Sided Unit Walls and Dividers with or without 2″ to 4″ Thick Insulated Floors, Walls, Ceilings, and Partitions, with Fiberglass or Styrofoam for Cooling/Heating Model Units as shown in FIG. 12 this patent and also shown FIG. 1 through 5 and also FIG. 11 Item b and FIGS. 12 and 13

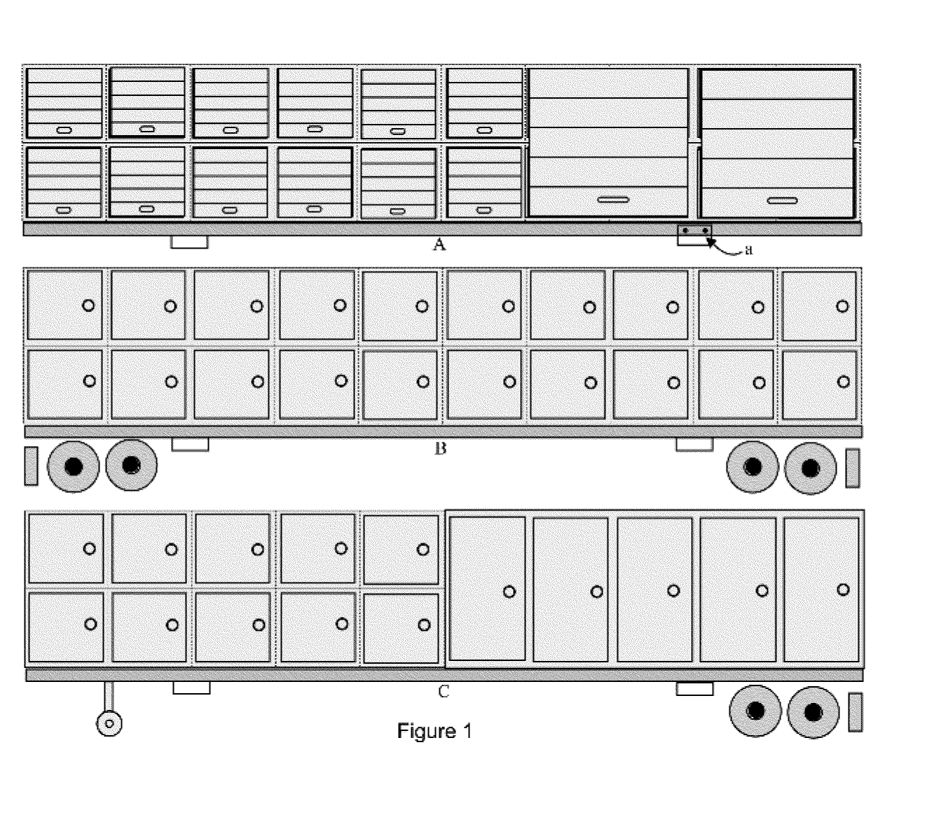

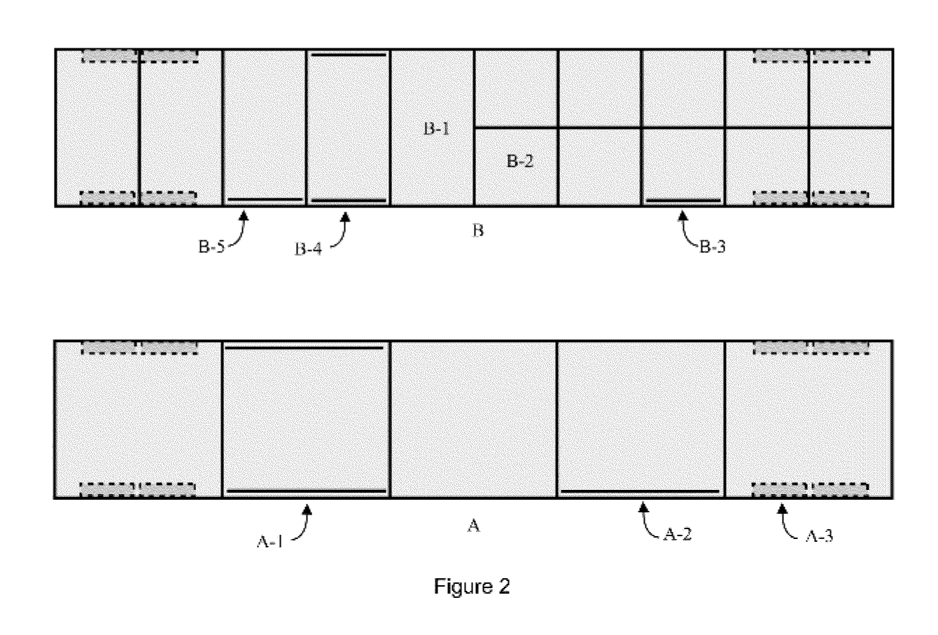

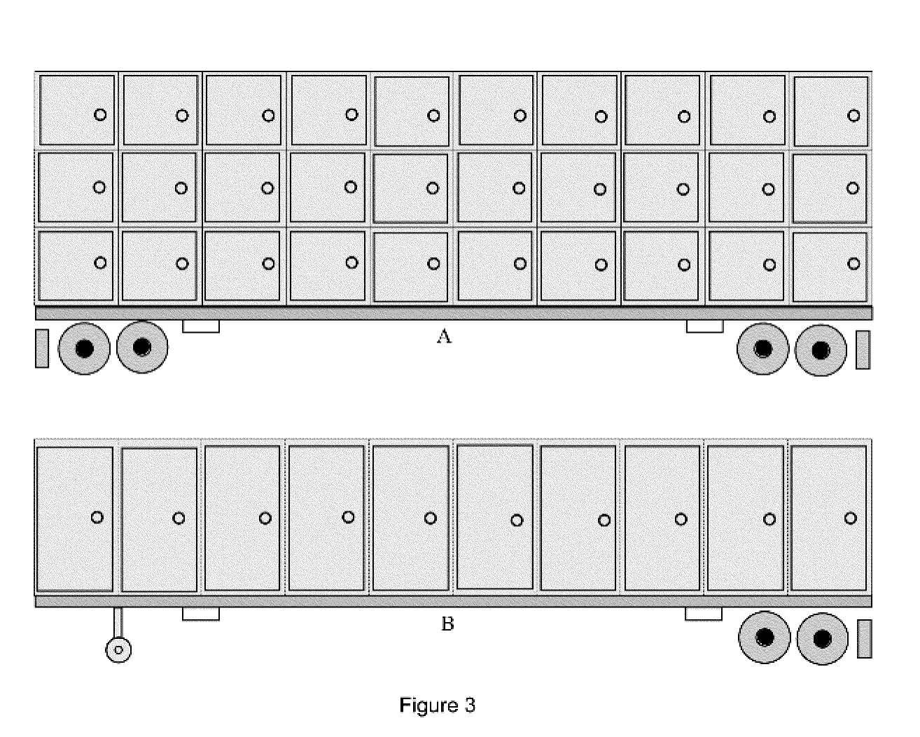

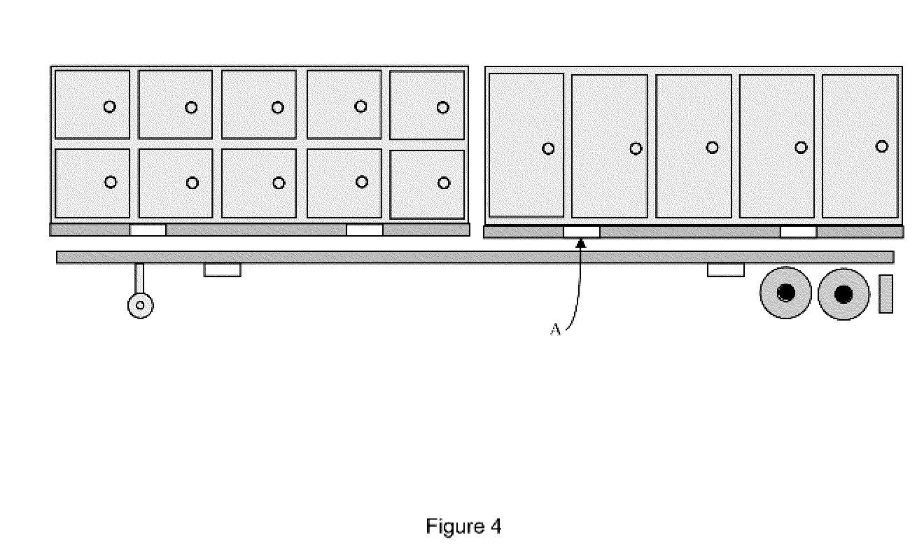

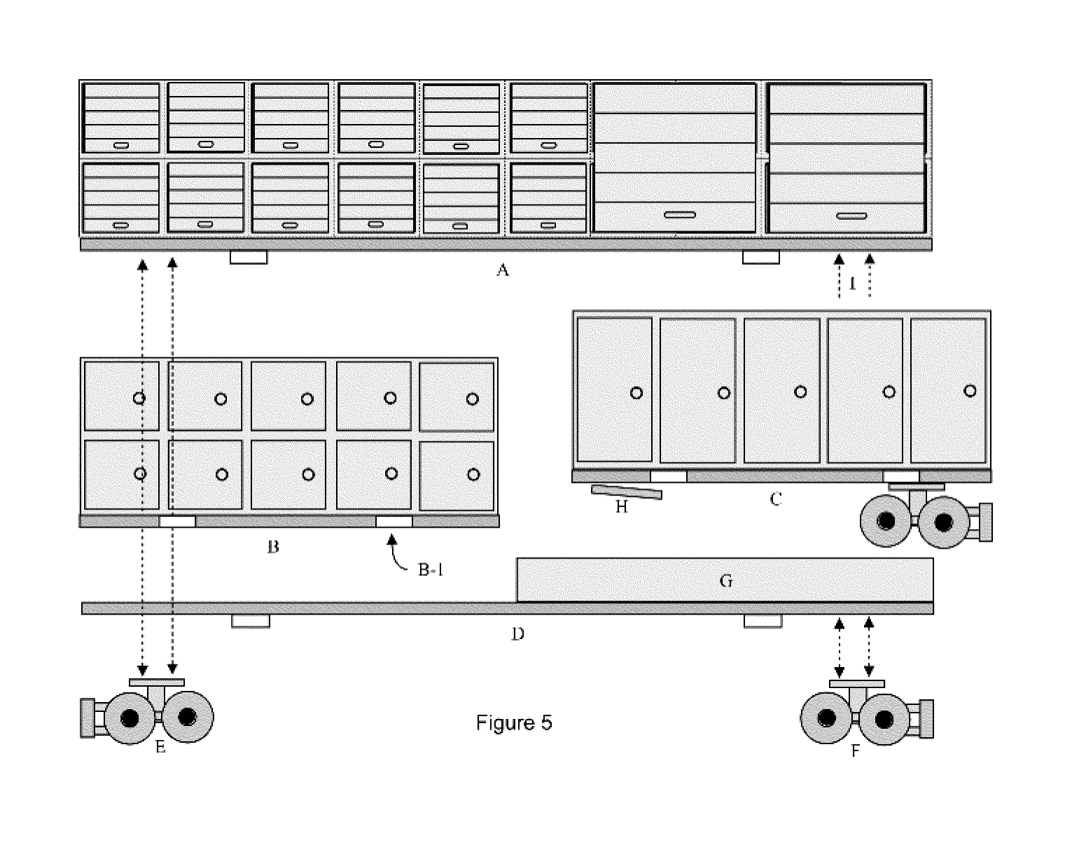

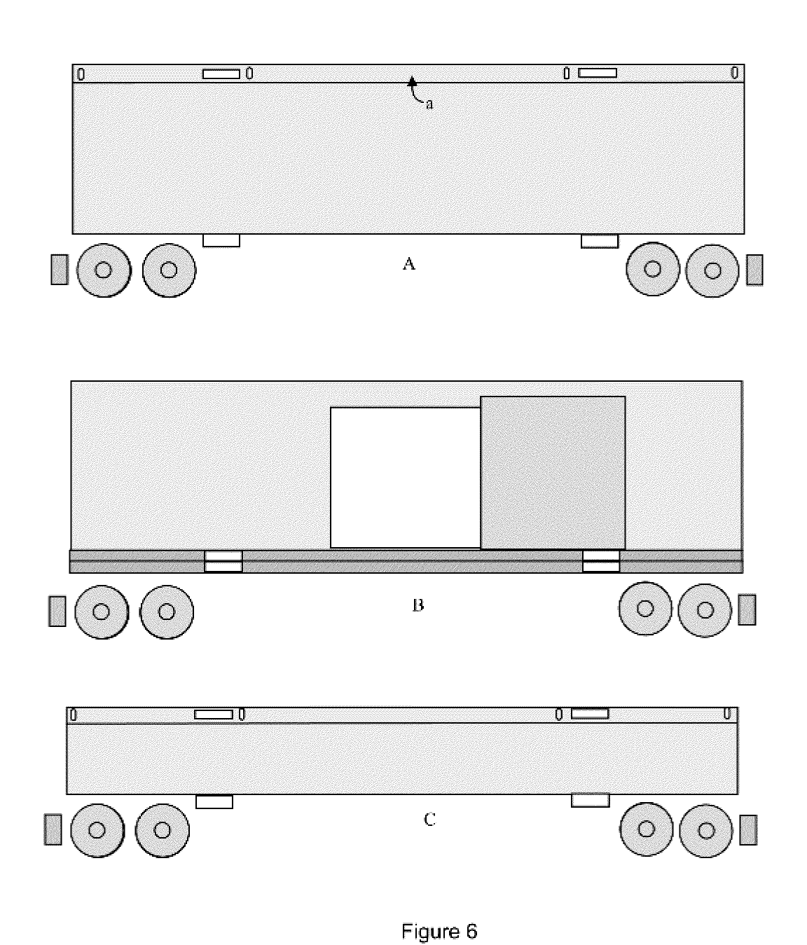

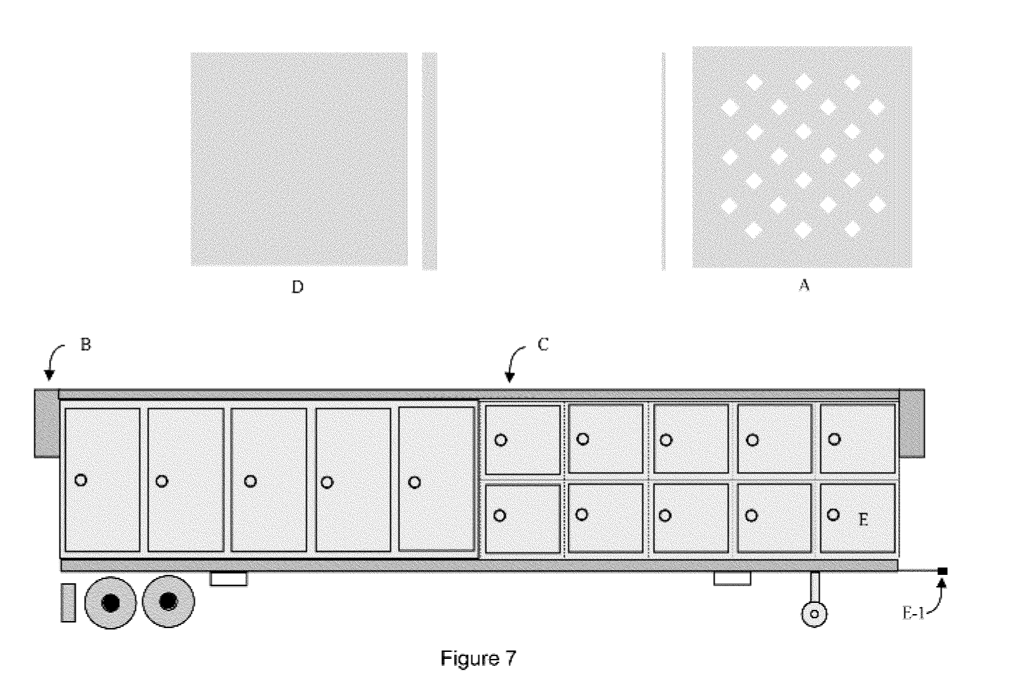

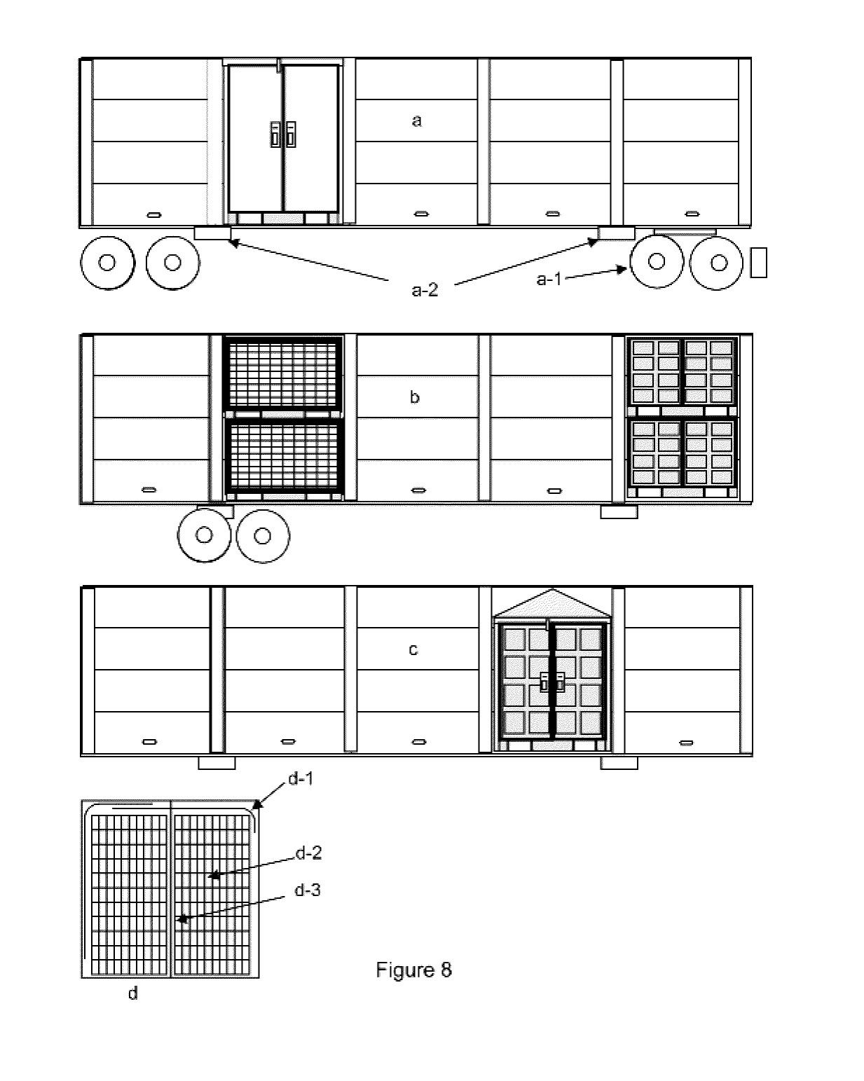

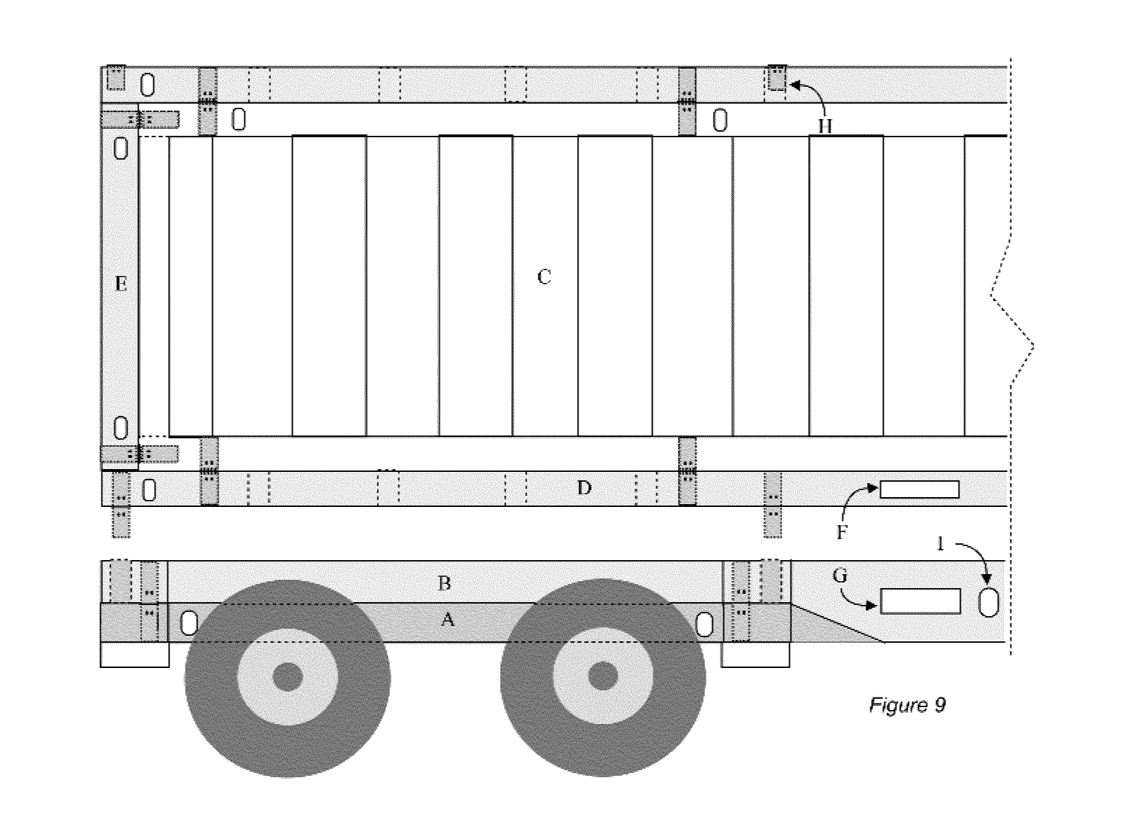

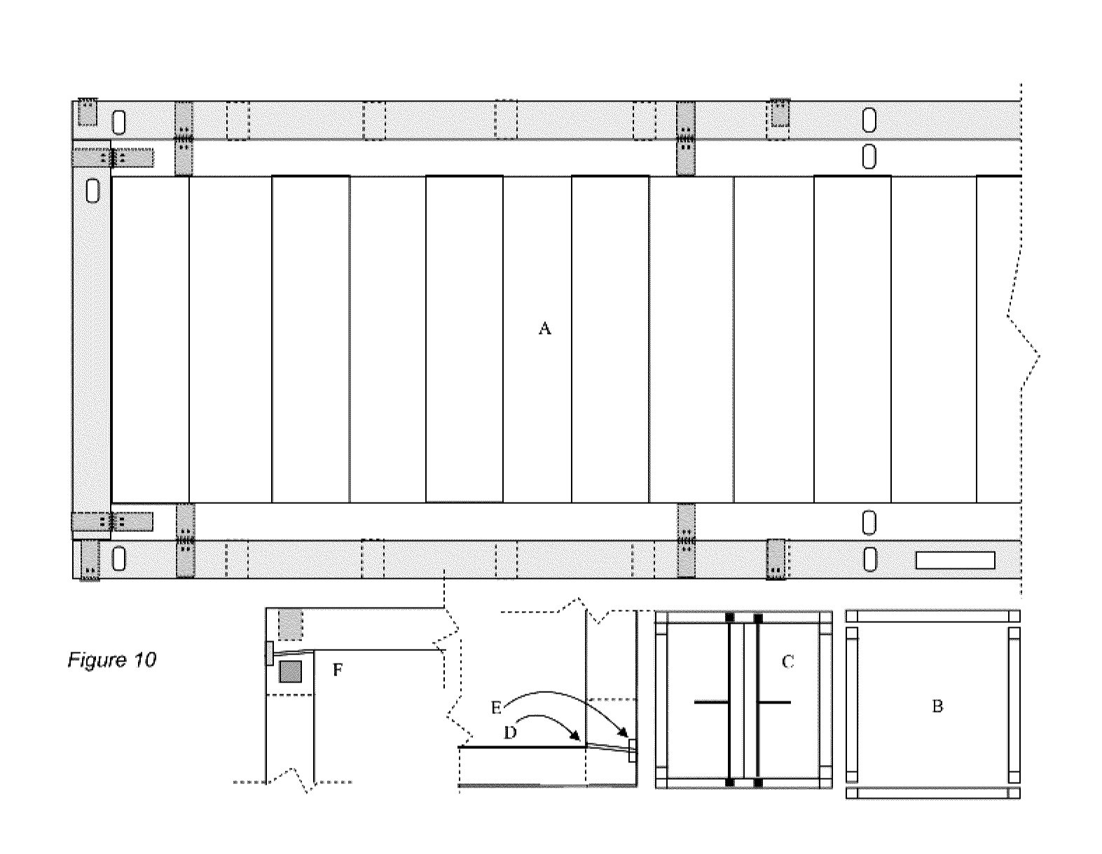

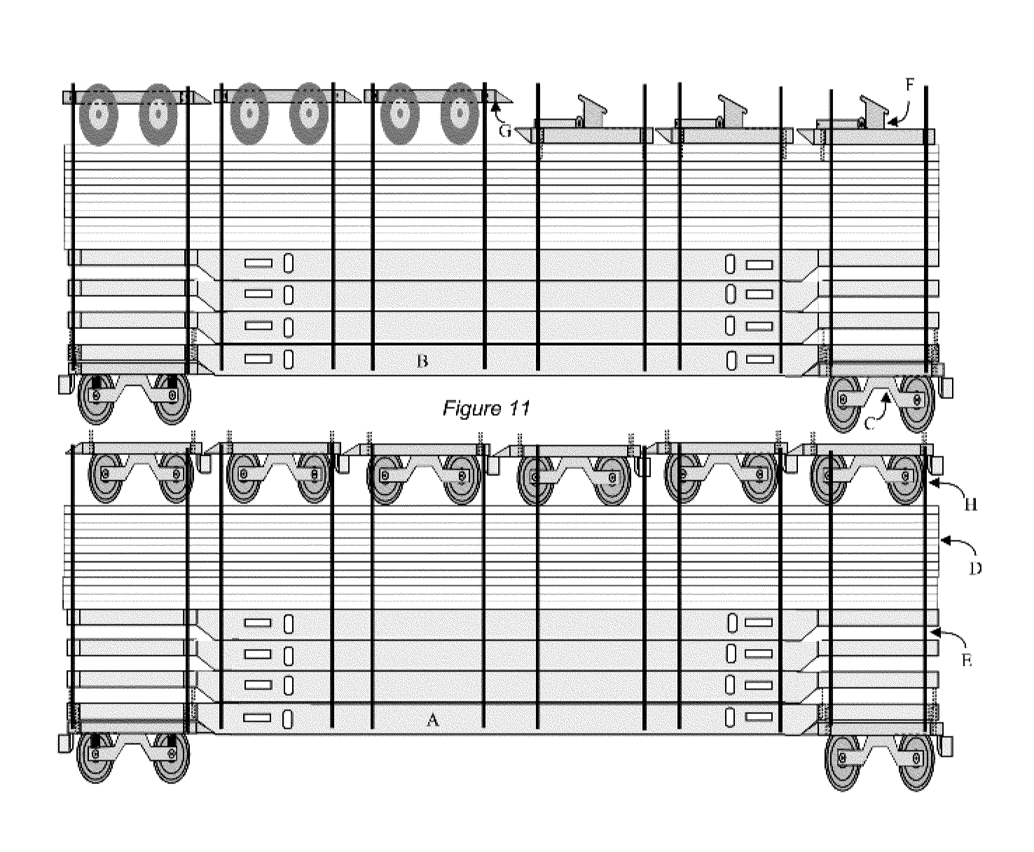

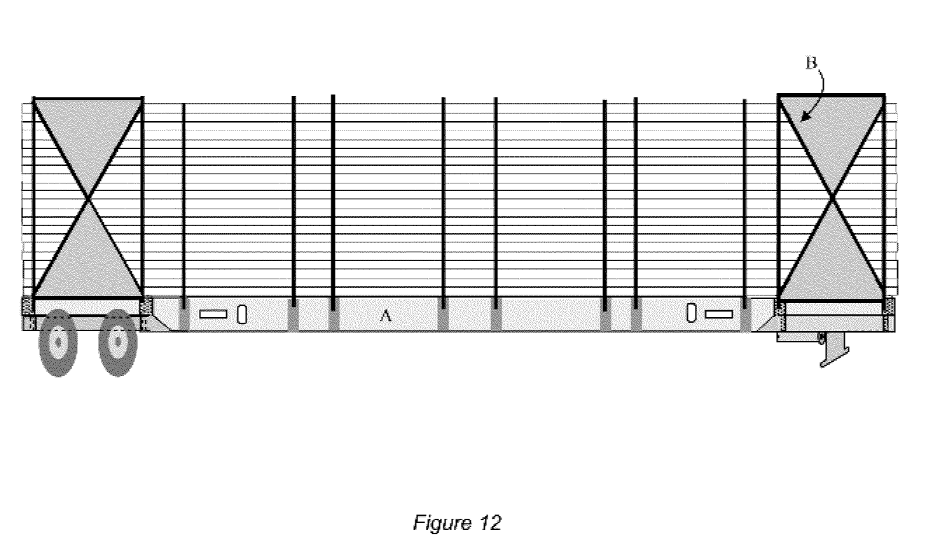

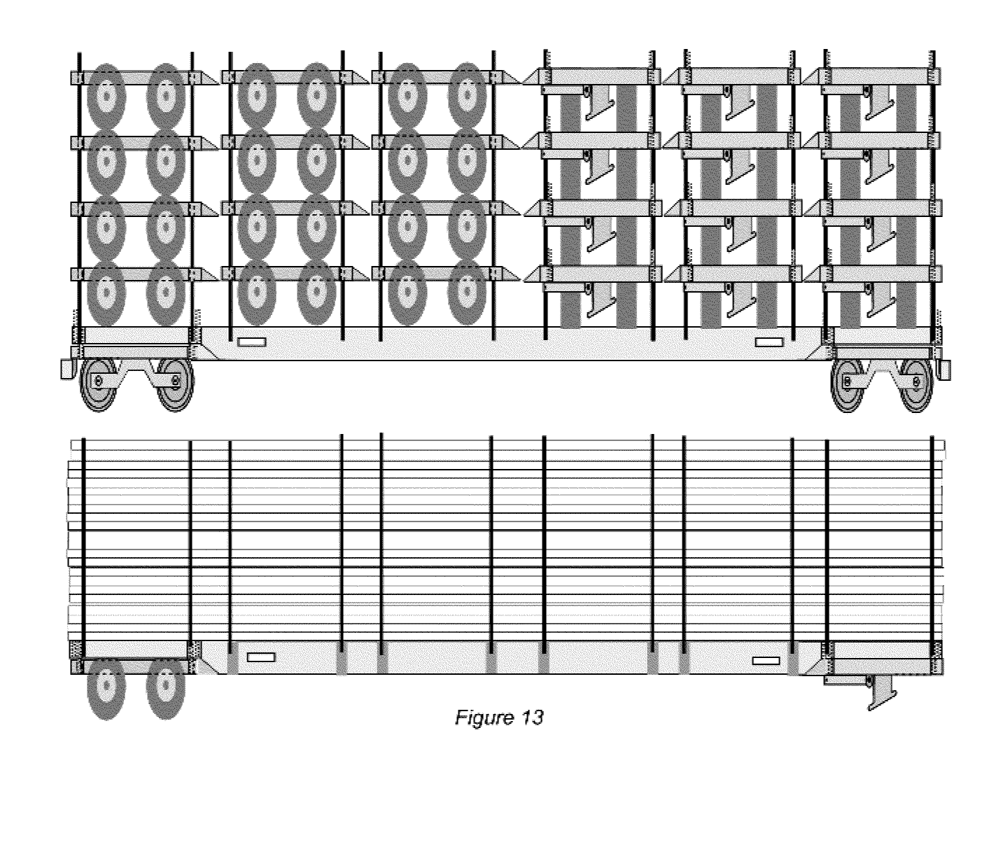

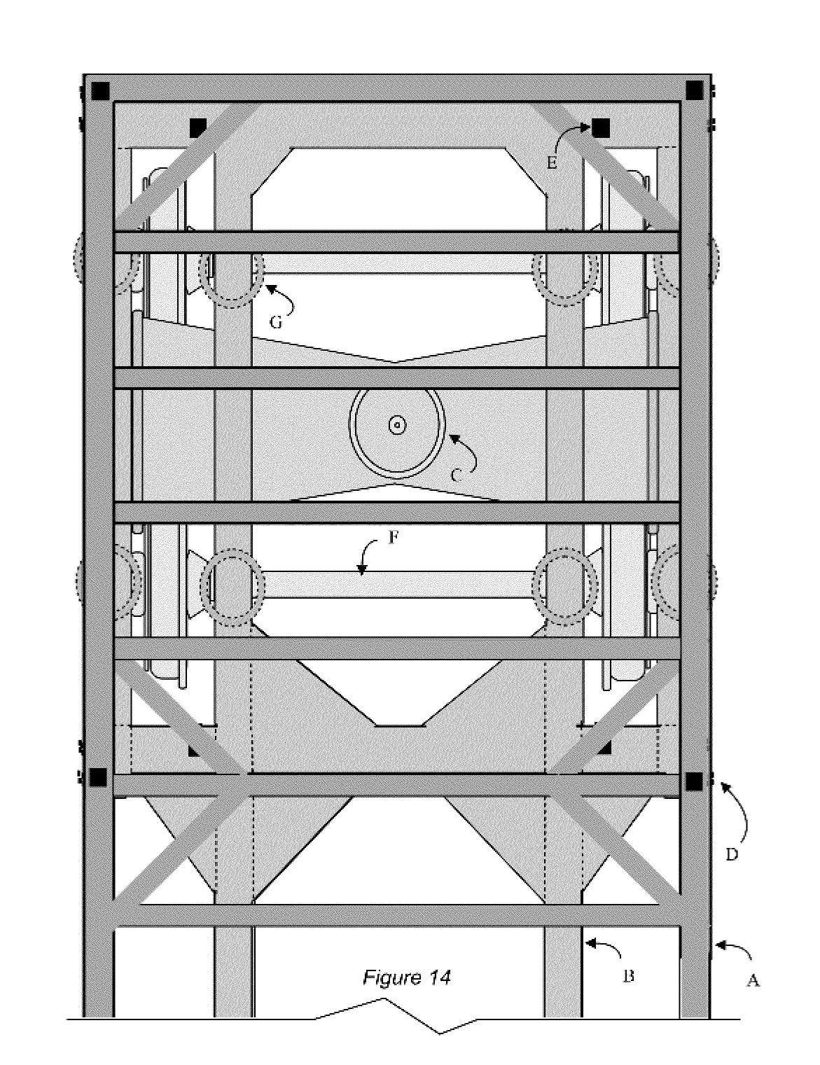

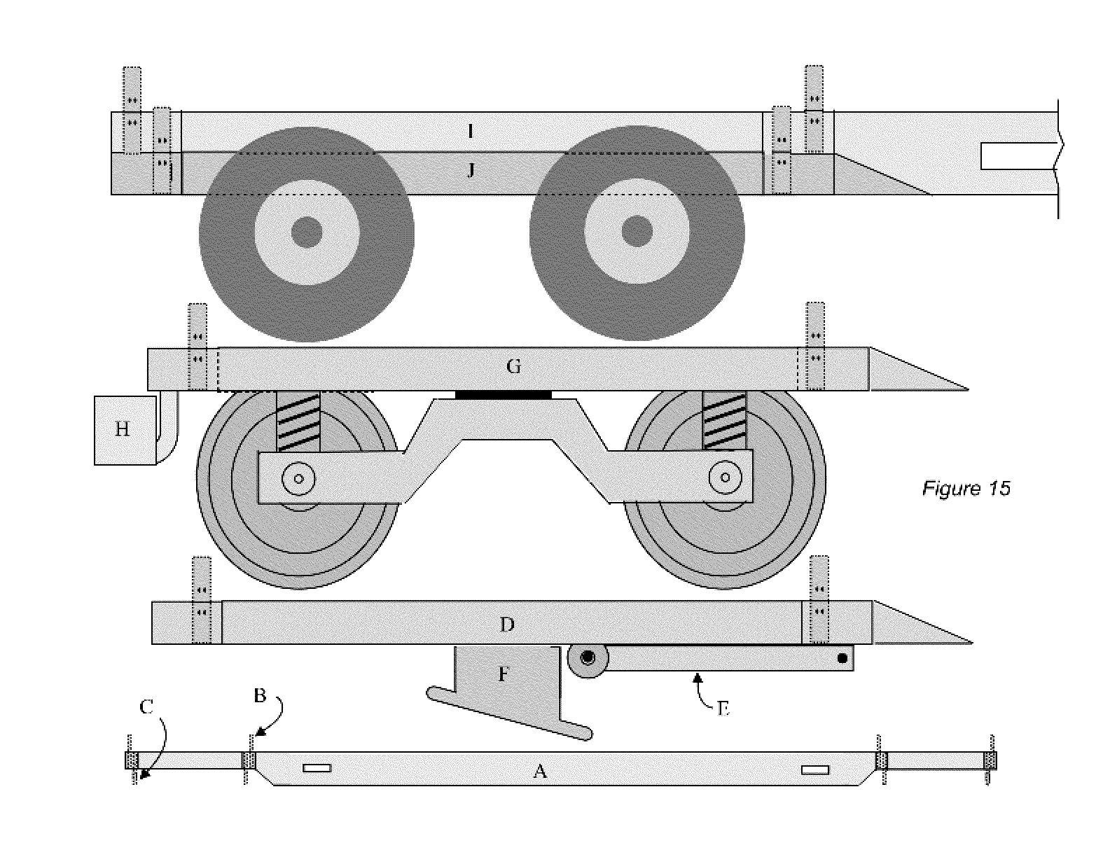

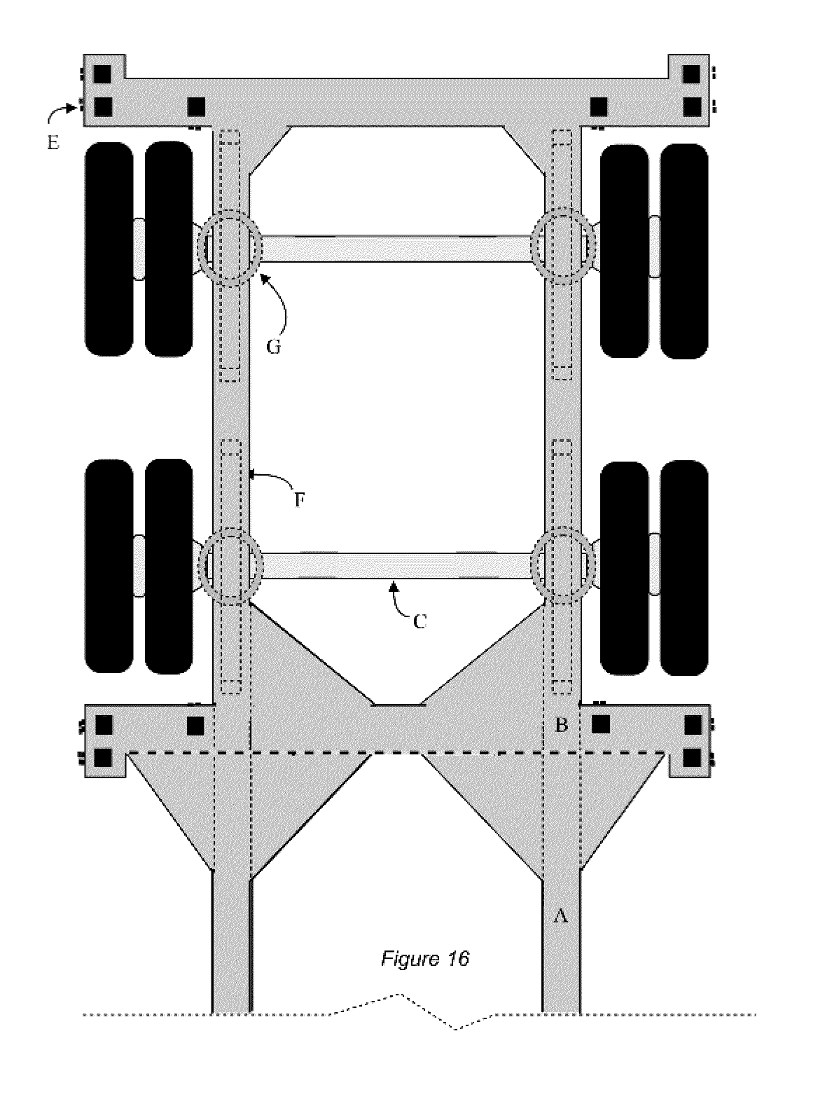

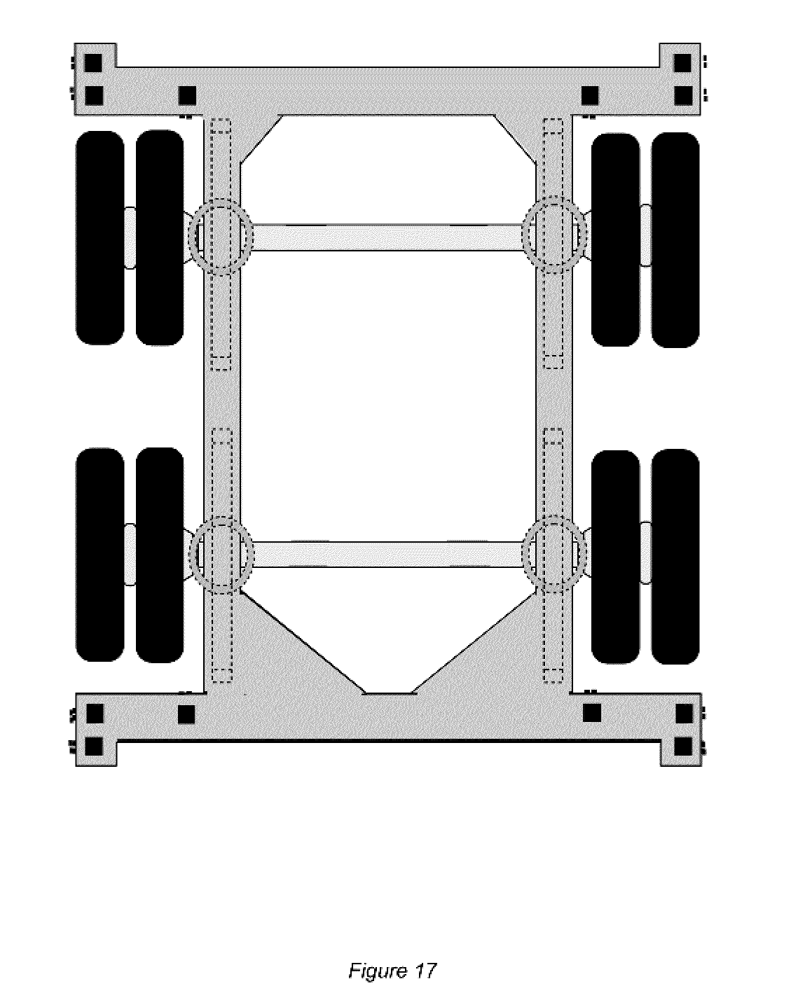

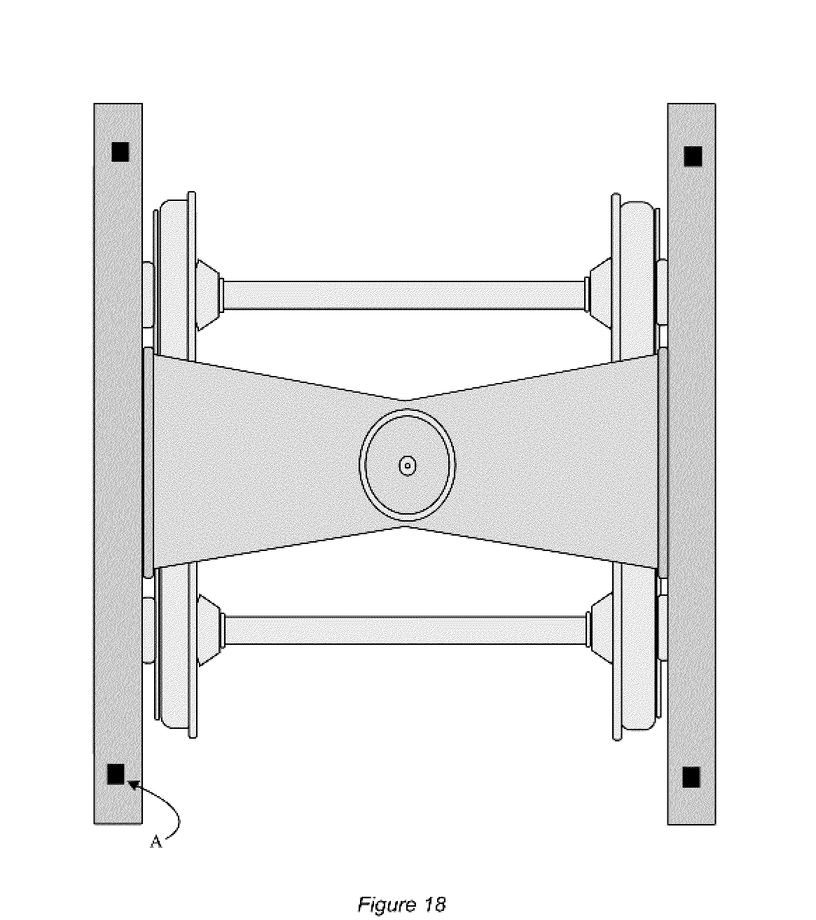

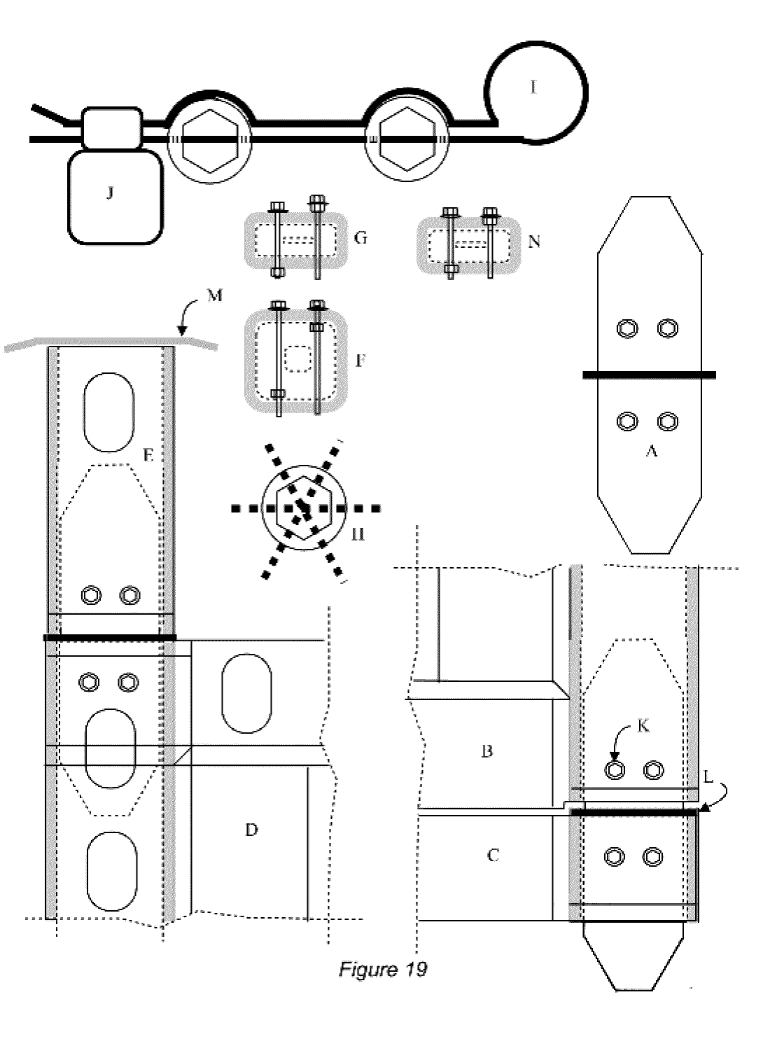

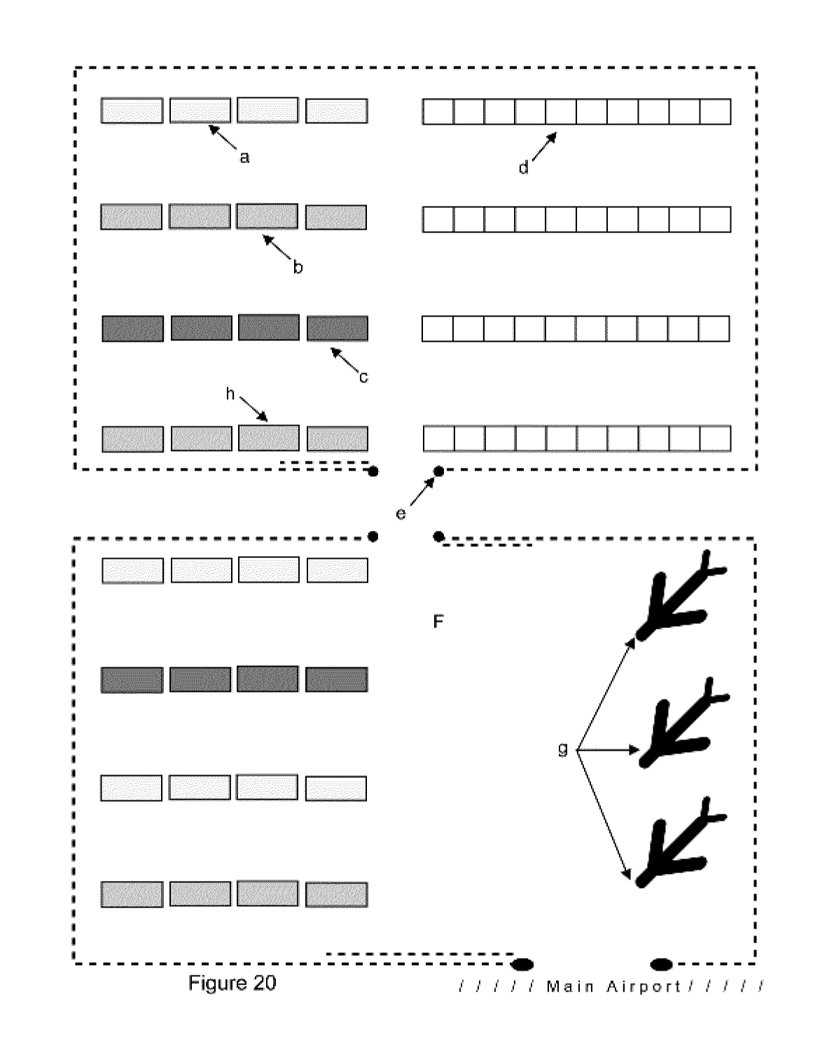

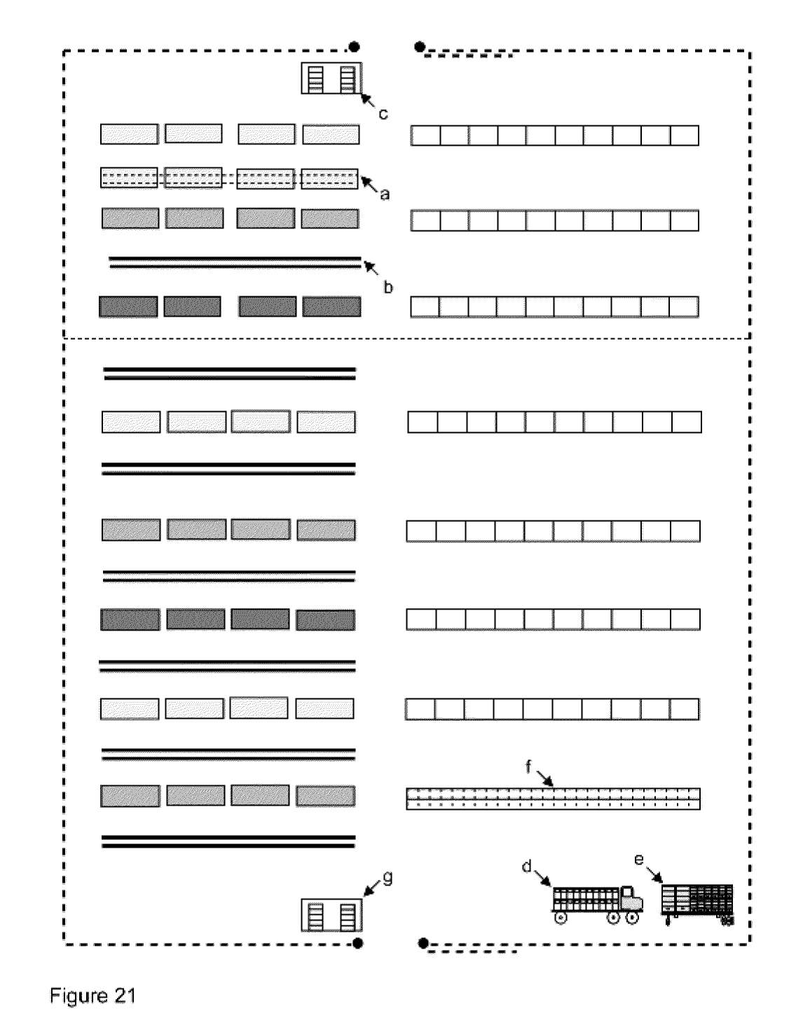

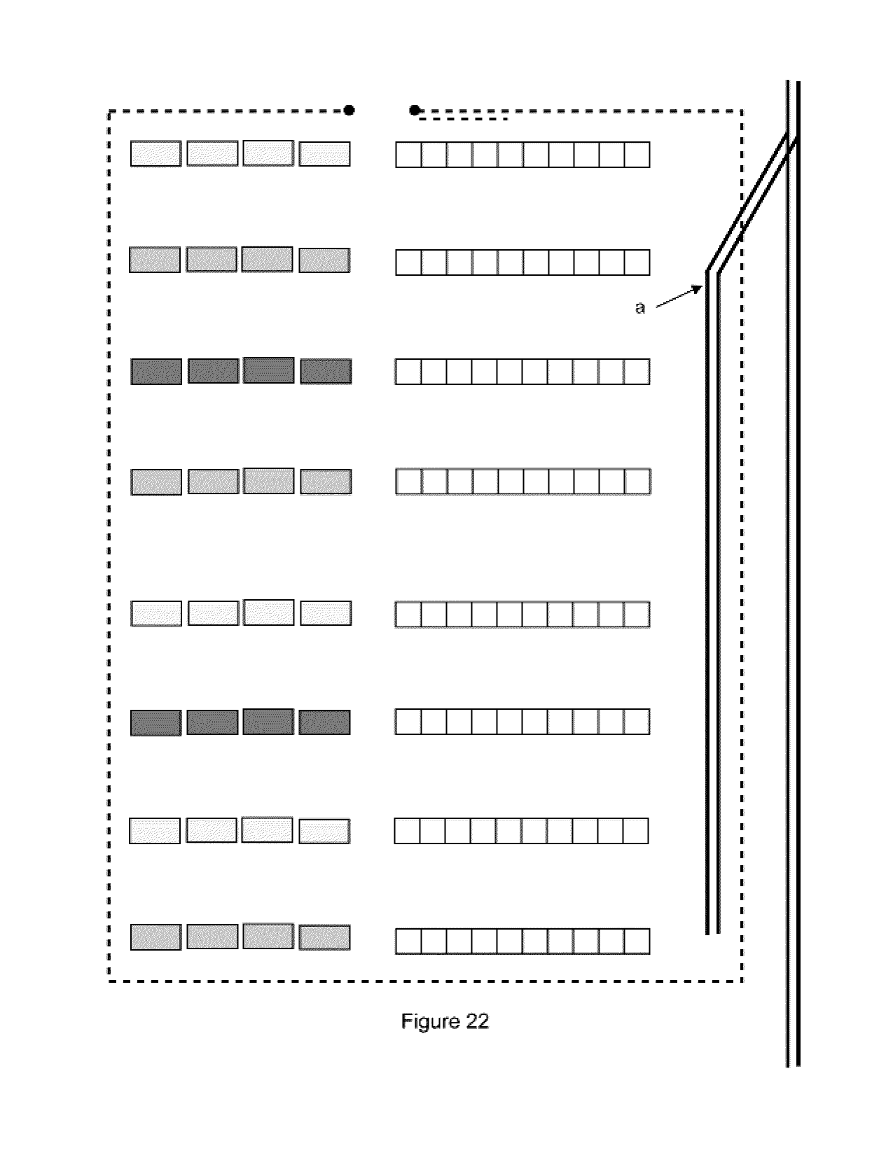

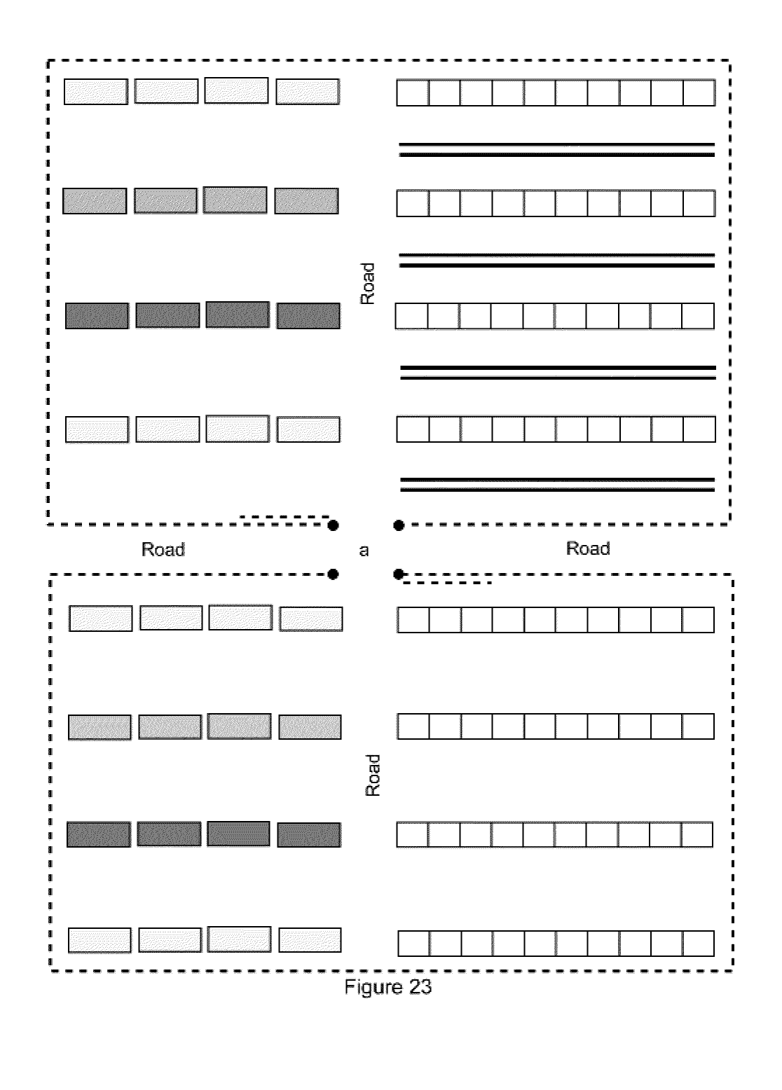

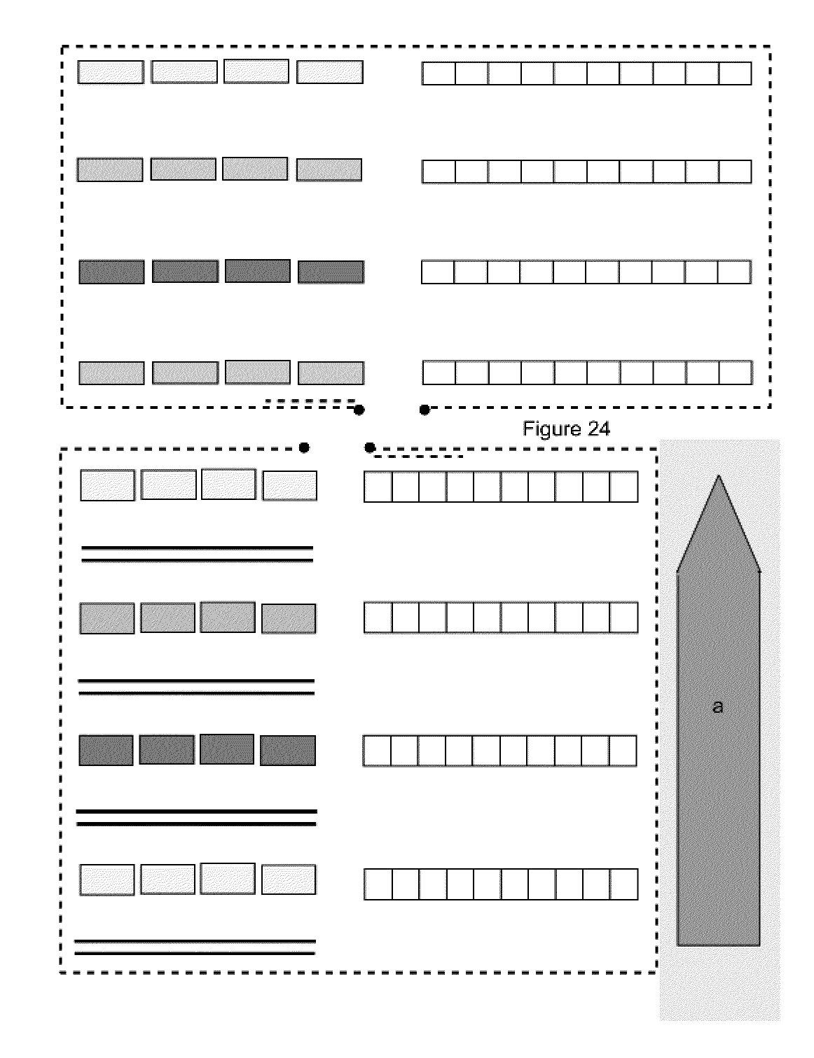

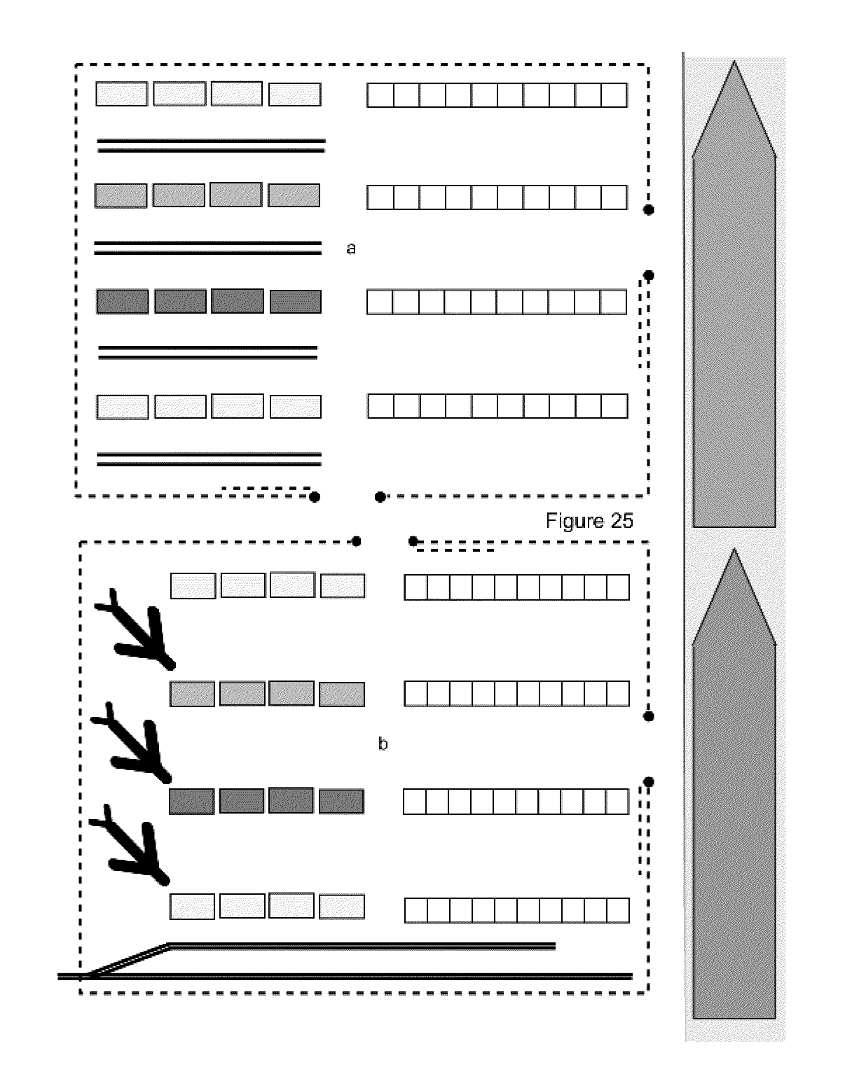

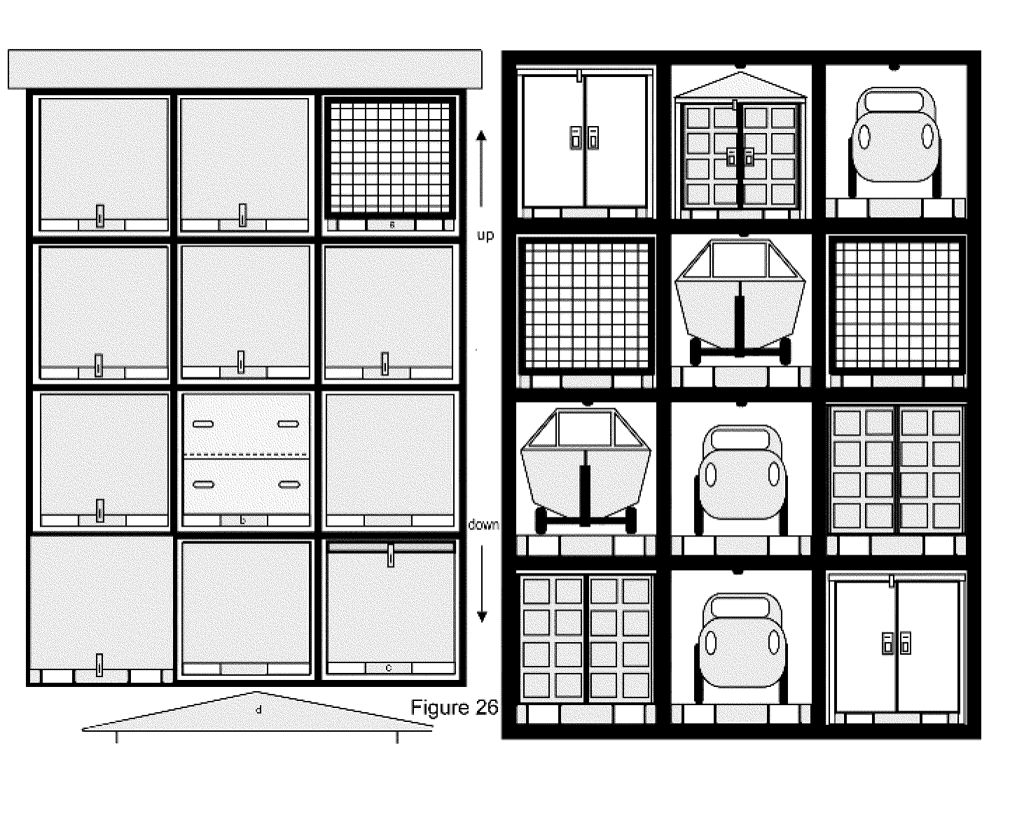

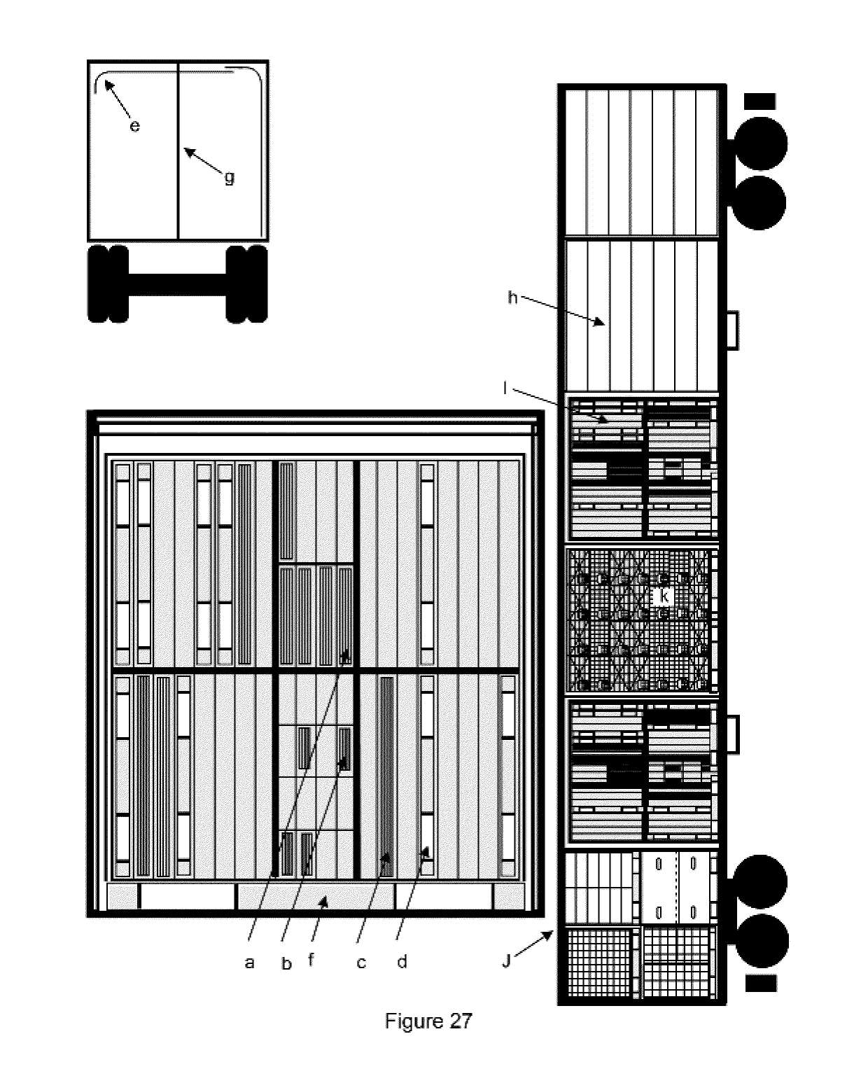

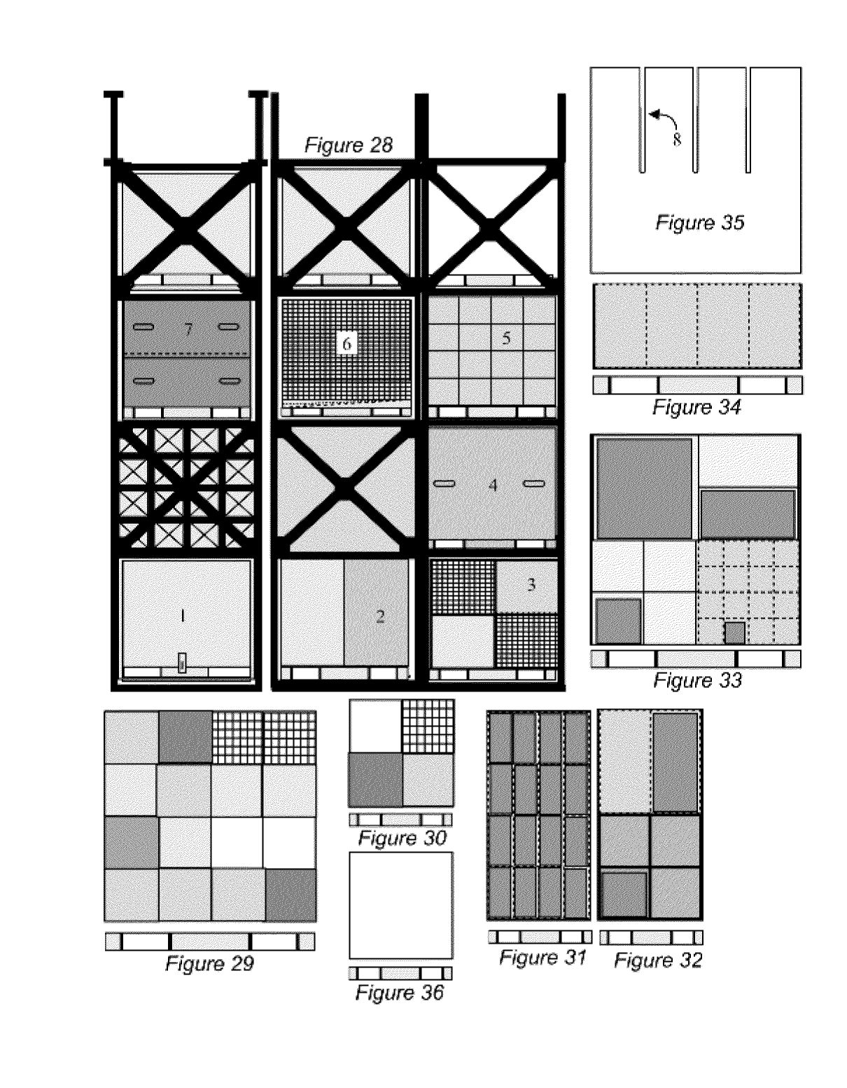

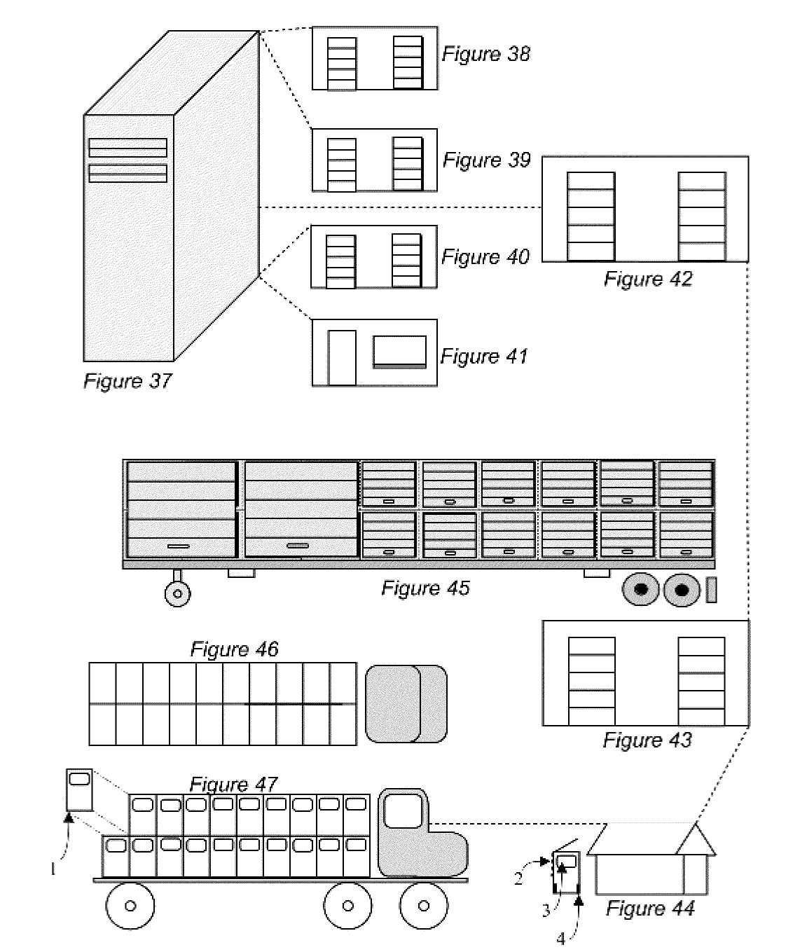

A. Full Storage and Transportation Unit divided into Two Sizes of Subunits, One Half divided into 4′6″ by 4′6″ Subunits and the Other Half divided into 4′6″ by 9′, a. Detachable Forklift Rectangular Steel Tube with Brackets and Two Allen Cap Screw Bolt Holes into Car Frame for use with all Cars and Containers shown in FIGS. 1 through 10 including Retro Fit Existing Cars and Semi-Trailers, Units may be attached to the bottom of Main Frames or Container attached Sub-Frames
B. Full Storage and Transportation Unit divided into 4′6″ by 4′6″ Double Height Subunits
C. Wheel Removed Stackable 5 to 8 High Full Storage and Transportation Unit divided into Two Sizes of Subunits, One Half divided into 4′6″ by 4′6″ Subunits with Rolling Sectional Door and the Other Half divided into 4′6″ by 8′9″ or 12′9″ Wide by Full Unit Height

FIG. 2 Top View of Rail Car, Semi-Trailer, or Shipping Container, Full Units divided into Storage and Transportation Subunits. Also shown in the Original Provisional Patent Application No. 61/148,135 FIG. 4 Items A through D, A. Storage and Transportation Subunits, 8′9″ or 12′9″ Wide Subunits by 8′9″ Minimum Height by Full Width of the Full Unit Containers with Door Rolling Sectional Type Steel Door Subunits, Single or Double Sided Subunit Doors, Single or Multiple Sized Subunits as shown in FIG. 2, Item A-1 Double Slide by Rolling Sectional Type Steel Door Horizontally Hinged with Dead Bolt Locks or Double or Triple Dead Bolted Pad lockable as shown in Original Provisional Application 61/148,135 FIG. 4 Item D-1, Item A-2 Single Door Rolling Sectional Type Steel Door Horizontally Hinged with Dead Bolt Locks or Double or Triple Dead Bolted Pad lockable, Item A-3 Wheels of Railroad Car or Semi-Trailer where Applicable, Item B. Storage and Transportation Subunits showing Partitions, Item B-1 Storage and Transportation Subunits with Single or Double Subunit Doors, Storage Size 4′6″ to 5′ Wide by the Full Length of the Main Unit by the Full Height of the Main Unit, Item B-2 Storage Units with 1 Opening Door Each Unit, Storage Size 4′6″ to 5′ Wide by Half Width of the Main Unit, Layouts can be expanded to include all 4′6″ to 5′ Wide Units by 4′6″ to 5′ High by Double or Triple Height as shown in FIG. 2 Item B and FIG. 3 Item A Item B-3 Rolling Sectional Type Steel Door Horizontally Hinged with Dead Bolt Locks or Dead Bolted Pad lockable or Single Steel Door Vertical Hinged Swing Open with Dead Bolt Locks or Dead Bolted Pad lockable with Door Knobs as shown in FIGS. 13 and 14, 4′6″ to 5′ Wide by 4′6″ to 5′ High, Item B-4 Double Slide by Rolling Sectional Type Steel Door Horizontally Hinged with Dead Bolt Locks or Dead Bolted Pad lockable or Single Steel Door Vertical Hinged Swing Open with Dead Bolt Locks or Dead Bolted Pad lockable with Door Knobs, 4′6″ to 5′ Wide by 4′6″ to 5′ High or 4′6″ by 9′ High, Item B-5 Rolling Sectional Type Steel Door Horizontally Hinged with Dead Bolt Locks or Dead Bolted Pad lockable or Single Steel Door Vertical Hinged Swing Open with Dead Bolt Locks or Dead Bolted Pad lockable with Door Knobs, 4′6″ to 5′ Wide by 4′6″ to 5′ High or 4′6″ by 9′ High

FIG. 3 Side View of Cargo Shipping or Storage Container, Railroad Car, Semi-Trailer, or Cargo Container, Shipping and Transportation Units for Paletted Containers or Loose Storage Goods, A. Full Storage and Transportation Unit Triple Height for Rail Transportation with or without Full Height Rolling Door Units 4′6″ by 8′9″ or 12′9″ Wide by Full 12′9″ Unit Height 8′9″ High with 4′×4′ Rolling Door or Knob Door Units located above Rolling Door Unit, B. Full Storage and Transportation Unit divided into 4′6″ Wide by 8′9″ High Subunits with or without 4′6″×4′6″ Rolling Door or Knob Door Storage Units above Door Knob or Rolling Door Units

FIG. 4 Side View of Cargo Shipping or Storage Container, Semi-Trailer, Rail Car, or Cargo Container, Shipping and Transportation Units for Strap or Bolt-down Paletted Containers or Loose Storage Goods as shown in FIGS. 2 and 3 Except shown as a New Item 2 Fork Liftable Half Full Units 20-30′ Each on a Flat Bed Trailer A. Fork Lift Holes for Half Unit Storage and Transportation Units

FIG. 5 Storage and Transportation Full Units with Rail Car, Semi-Trailer Wheels, and Semi-Trailer Hitch, all interchangeable, with Quick Detachment and Assembly Component Hardware. Items B and C are Half Subunits with Built-In Fork liftable or Crane Moveable Frames, A. Side View of Storage and Transportation Container Full Unit with Frame Attached with Interchangeable Carriage Mounts for Attachment with Items E, F, and H, and in Attachment Position Noted by Item I, B. Multi-Height Subunits, Non-Frame Detachable and Built as Single Unit, Forkliftable tied down to Full Length Frames such as Item D in FIG. 5, B-1 Fork Lift Slots Integrated into Storage and Transportation Subunit Frame, C. Half Units Setup for Semi-Trailer Transportation with Detachable and Hitch as described as Item F, D. Full Length Frame Bolt-On for Half or Full Storage and Transportation Subunit or General Ground Shipment Cargo (Half Load or Full Load), E. Railroad Car Dual Axle, Wheels, Hitch, and Mounting Pedestal, F. Semi-Trailer Axle and Wheels with Rear Bumper and Mounting Pedestal, G. General Ground Shipment Cargo Load, H. Semi-Trailer Hitch, I. Mounting Position for Detachable Rail Wheels (Item E) or Semi-Trailer Wheels (Item F) or Semi-Trailer Hitch (Item H)

FIG. 6 The Interchangeable Standardized Modification of All Presently Existing and Newly Described in this patent Rail, Cargo, and Road, Shipping and Transportation Units with New Permanently Affixed Carriages or Interchangeable Carriages or Retro Fitting of All Existing Carriages to Interchangeable on all Cars, Trucks, and Containers, including all New Fork Lifting Slots and Hook Lifting Holes for Rail Car, Semi-Trailer, or Cargo Shipping Container, as shown in FIGS. 1 through 19

A. Open Top Unit Heavy Duty Open Box, Rail Car, or Semi-Trailer, (a) Retro Fit Top for Existing Full Height Hopper Cars with Bolt and Pin Attachment System as shown in FIGS. 9 and 10 of this patent
B. Single Sliding Door Dual Side Opening Unit New or Existing Rail Car or Semi-Trailer with Wide Fork Lift able Slotted Frame, with or without Double Sided Unit Walls and Dividers 2″ to 4″ Thick Insulated with Fiberglass or Styrofoam for Cooling/Heating Model Units as shown in FIG. 7 of this patent
C. Half, Three Quarters, or Full, Height, Open Box, Heavy Duty, Rail Car, Semi-Trailer, or Coal Car, Wide Forklift able with Two Detachable Wheel Carriages as shown in FIGS. 14 through 19, or with Double Frame as shown in FIG. 6 Item B with Removable Top as shown in FIG. 6 Item (a)

FIG. 7 Refrigeration, Freezer, or Climate Controlled, Storage or Transportation Unit as shown and described in FIGS. 1 through 5 and FIGS. 8 and 9, A. Air Flow through Partition in various sizes located between all Internal Storage Unit Walls for Cold Air Flow (Non-Insulated), B. Cooling Unit Insulated—Full Temperature Range (0 to 80 Degrees) for 3 Types of Usages (Refrigeration, Freezer, or Climate Controlled, Storage or Transportation Units) C. Insulated Duct Work with Individual Unit Vents, Small Sub-unit Vents run through Interior or Center Walls, Half Car AC Units or Full Car AC Unit, D. Solid Styrofoam or Fiberglass Insulated Storage and Transportation Sub-Unit Walls, E. Cooling/Heating Fuel Storage Tanks and Equipment for Electric Generator or Cord Plug-In or Compressed Gas Operation, E-1 Rail Car to Rail Car Plug-ins for Single Engine or Caboose Mounted Whole Train Generators, also Electric Company Plug-ins at Rail Yards and other related Rail, Trucking, Air, and Shipping, Yards as shown in FIGS. 1 through 5 and FIGS. 8 and 9 of this patent

FIG. 8 New Construction Rail Cars or Retro Fitted Existing Rail Cars or Carriages, a. Rollup Door (3 to 8 Doors Each Side) Railroad Boxcar, Divided or Undivided Compartments for each Double Door Section, Divided Cars can be used for consumer or commercial moving and storage, Existing Units may be retrofitted or new construction depending on supply and demand. A-1. Four Wheeled, Two Axle Railroad Carriage attached to Ocean Shipping Cargo Container, Bolted Eight Places, A-2. Wide Fork Lift Holes Two Places Typical on Each of the 3 Containers Shown, b. Rollup Door (3 to 8 Doors Each Side) Semi-Trailer, c. Rollup Door (3 to 8 Doors Each Side) Overseas Shipping Container Capable of Accepting Either Tractor Trailer Wheels or Railroad Car Wheel Carriages as described in FIGS. 9 through 18., d. Side View of Items a, b, and c, D-1 Double Rolling Door Units Passing Each Other, D-2 Partition Walls, Sheet Steel or Heavy Wire Mesh between Units as shown in FIG. 2, D-3 Center Divider Entire Car Length or Removable Center Divider depending on Cargo Size, D-2 and D-3 Double Sided Unit Walls and Dividers 2″ to 4″ Thick Insulated with Fiberglass or Styrofoam for Cooling/Heating Model Units as shown in FIG. 12 this patent

FIG. 9 Six Piece Quick Erect Pin and Bolt Fastened Multi-Purpose Container for use with or without a Quick Erect Interchangeable Frame and Carriage System for Rail Car and Semi-Trailer, Fastening Methods are also described in FIG. 19, The containers are manufactured in Sizes of 10′, 20′, 40′, or 50′ Long, or Longer depending on Road Regulations and 9′3″ to 11′ Wide and High depending on Road or Rail Regulations, All Units in this patent will be world wide standardized based on International Regulations, A. Semi-Trailer Wheels and Carriage Assembly with Fork Lift Slots and Crane Hook Holes for Transfers of Systems Components, also shown in FIGS. 11, through 17, B. Car Frame for use with Assembly described in FIG. 9 Item A having Removable or Fixed Insert able Pins with Cross Bolts to secure the Carriage to the Frame, Frame Assembly also shown in FIGS. 14 through 19, C. Corrugated Metal with Top and Bottom welded on Square Tubing Container Side Pieces. The Containers are Pin and Bolt Fastened and have Hook Holes for Lifting Sections into Place to complete the Six Sided Container, D. Bottom and Top of Container containing Frame and Double Sided Full Width and Length Sheet Metal Panel Surfaces with Hook Lift Holes for Lifting the Pieces or the Whole Assembly Loaded or Unloaded, E. End Pieces of Container suitable for Door Frame Model as shown in FIG. 10 Item C or Corrugated End Piece Model as shown in FIG. 9 Item C, F. Forklift Slot for Lifting Individual Bottom or Top Piece or Entire Container, G. Forklift Slot for Lifting Car Frame, H. Hole for Attachment Pin allowing for precision stacking of Containers and wind and ocean wave movement restriction, I. Crane Lift Hook Holes for Lifting Car Frame

FIG. 10 Six Piece Quick Erect Container as described in FIG. 9 with views, A. Six Piece Quick Erect Container, B. Separated Two Side Pieces and One Each Top and Bottom Pieces for Quick Construction Containers, C. End Piece showing Semi-Trailer Type Closing Doors, also Front Piece (Not Shown) having Corrugated Construction as shown in FIG. 10 Item A, D. Side and Bottom of Container Intersection Seam 7.5 Degree Angle for Rain Shedding on All Bottom Sides of Container with Rubber Seal between Two Pieces, E. External Rubber Seal Weatherproofing attached Compressed Foam, F. End and Top of Container Intersection Seam 7.5 Degree Angle for Rain Shedding on All Top Sides of Container with Rubber Seal between Two Pieces

FIG. 11 Rail Car stacked with Quick Construct Container Frames and Railroad Wheel Carriages, A. Interchangeable Car Frame with Railroad Wheel Carriages stacked with Components for assembling 3 additional Rail Car Assemblies, B. Interchangeable Car Frame with Railroad Wheel Carriages stacked with Components for assembling 3 additional Semi-Trailer Assemblies, C. Interchangeable Carriage Frame Assembly for Rail with or without Springs, D. Quick Erect Container Sides and Top and Bottom and End Pieces, E. Square or Rectangular Tubing Long Pieces inserted through Component Attachment Pin Holes to hold Components from movement during shipping, typical 12 places as shown, F. Semi-Trailer Hitch and Interchangeable Frame Assembly with Temporary Wheels, G. Semi-Trailer Wheels and Interchangeable Frame Assembly

FIG. 12 A. Interchangeable Car Frame with Semi-Trailer Wheel Carriages stacked with Components for assembling 6-8 Additional Container Assemblies, B. Crossed Welded Steel Tube and Sheet Metal Cross Bracing Assemblies, Sides, Front, and Back, for Movement Resistance during Shipping,

FIG. 13 Two Drawing Figures, One showing Semi-Trailer Interchangeable Carriage Components, the other showing Stacked Six Piece Quick Construct Container Sides, Tops, Bottoms, and End, Pieces,

FIG. 14 Cutaway Top View of a Rail Car, Semi-Trailer, or Container, Frame with a Four Place Pin and Bolt attached Main Frame and underneath attached Pivoting Rail Carriage Assembly, A. Top View of a Rail Car, Semi-Trailer, or Container, Frame Only with Six Cross Braced 45 Degree Angle Welded Frame Members (Dark Shaded) with Four Pin Holes for an attachment to Main Frame underneath, shown as Item D, B. Main Frame for Interchangeable Carriage attachment and attachment to Container, Car, or Semi-Trailer, Floor and Floor Frame, C. Rail Carriage Pivot for Carriage Direction Adjustment during Rail Travel Track Curvature Adjustment (Rail Car Turning), D. Bolt Heads for Double Cross Bolted Retaining Pin as shown in FIG. 15 Item C and FIG. 19, E. Main Frame Retaining Pin Holes for attaching Main Frame to underneath Rail Carriage as shown in FIG. 15 Item C, F. Rail Axle and Wheel Assembly, G. Coil Springs, Inner Frame or Outer Frame Mounted, One, the Other, Both, or None, depending on the Engineering Requirements

FIG. 15 Interchangeable Carriages and Main Frames for Semi-Trailers or Rail Cars, A. Main Carriage Frame with Installed and Bolted Pins, B. Carriage Pins for attachment to Container Frame, Rail Car Frame, or Semi-Trailer Box, Bolted in Place or Permanently Welded in Place as shown in FIG. 19, C. Carriage Pins for attachment to Interchangeable Carriages as shown in Items D, G, and J, D. Semi-Trailer Hitch and Temporary Wheels Interchangeable Carriage Assembly with Installed Frame Attachment Pins, E. Semi-Trailer Temporary Wheels in retracted position, F. Semi-Trailer Hitch, G. Rail Carriage Assembly with Installed Frame Attachment Pins, H. Railroad Car Hitch for Carriage to Carriage Connection, I. Interchangeable Carriage Main Frame with Pins installed for both Container Frame and Interchangeable Semi-Trailer Wheels Carrier, J. Semi-Trailer Carriage Assembly

FIG. 16 A. Top View of an Interchangeable Carriage Main Frame with Pin and Bolt Attached Semi-Trailer Wheel Carriage underneath on the bottom, B. Interchangeable Semi-Trailer Wheel Carriage Assembly with Main Frame on top, C. Axle and Semi-Trailer Wheel Assembly, D. Pin Holes with Pins and Cross Bolts Inserted (Four Places for Frame to Frame Securing, also Eight other Places for Carriage to Main Frame Securing and Container Frame to Main Frame Securing, E. Pin Securing Cross Bolts (Two per Pin Half—Four Total as shown in FIG. 19 Item A), F. Leaf Springs, G. Coil Springs or New Front Only Secured Coil Springs

FIG. 17 Semi-Trailer Wheel Carriage without Pin and Bolt attachable Main Frame shown in FIG. 16, Side View shown in FIG. 15 Item J

FIG. 18 Railroad Wheel Carriage without Pin and Bolt attachable Main Frame shown in FIG. 16, Side View shown in FIG. 15 Item G

FIG. 19 A. Component Attachment Pin with Two Bevel Angle Ends for Easy Hole Alignment and Four Cross for Allen Head Cap Screws or Security Anti-Tamper Bolt Head Cap Screws, 1″ to 1.5″ in Diameter, with Threaded Ends and/or Shoulder, also a Center Flange shown in Item L as a Quick Stop for Bolt Alignment, Threads should be ACME thread for strength and durability and lock washers should be used. B. Bottom Corner of Sub-Frame Pin Attachment Area of Various Interchangeable Storage or Shipping Containers shown and described in this patent or Retro Fit or New Rail or Highway Car, C. Bottom Corner of Main Frame Pin Attachment Area as shown in FIGS. 9 through 16, shown with Removable Pin Inserted and Two Cross Bolts in Place, D. Top Corner of Sub-Frame Pin Attachment Area of Various Interchangeable Storage or Shipping Containers shown and described in this patent or Retro Fit or New Rail or Highway Car, showing Various Potential Locations for Crane Lifting Hook Holes, E. Container Lifting Pin for Crane Lift Hook. This can also be made in a double pin ended sleeve with a total of four bolt holes to act as a spacer between containers (Not Shown). F. Square Shaped Double Ended Pin with Square Tube Sleeve (Thick Wall 4″ by 4″ Size) for Carriage and Main Frame Connection and Main Frame to Carriage Frame Connection, End View of Pin and Frame Mounted Pin Hole showing Beveled Pointed End Area in Center of Drawing and Two Cross Bolts, also showing Welded-On Threaded Nuts in Interior Pin Location (use one or more of these thread locations as necessary), G. Rectangular Shaped Double Ended Pin with Rectangular Tube Sleeve (2″ by 6″ Size) for Side Wall to Frame Attachments with Two Cross Bolts showing Welded-On Threaded Nuts in Exterior Sleeve Location, H. End View of Socket Head Cap Screw or Security Head Bolt with Cross Holes Drilled in Six Places for the Insertion of Double Bolt Retaining Pin shown as Item I, I. Double Bolt Retaining Pin shown inserted through Two Allen Head Cap Screws, J. Anti-Tamper Plastic Heat Seal or Non-Accessible Compression Fit Snap Lock for Double Bolt Retaining Pin, M. Container Weight Bearing Pad (4-12 Places depending on Container Size) for Spacing Container above Ground for Water Intrusion Protection (Visualize Drawing Upside Down from Present Position), N. Rectangular Shaped Double Ended Pin with Rectangular Tube Sleeve (2″ by 6″ Size) for Side Wall to Frame Attachments with Two Cross Bolts showing Tapped Holes through Sleeve Side Wall

*FIGS. 20 through 25 Storage Business Small and Large Containers Public or Restricted (Retail, Wholesale, and/or Flea Market, and Shipping Ports), Fenced Yards, with or without Office (not shown) Typical All Drawings 20 through 25 Franchised Retail or Wholesale Storage and Transportation Outlets Typical All Drawings 20 through 25 Various New Configurations of Storage and Shipping Combination Business Concepts

FIG. 20 Storage Containers Portable Rows Left Side of Drawings Typical Each Drawing FIGS. 20 through 25, three different types shown as 3 different shades of gray, Office and Equipment Storage Building Not Shown, Color Variations show the Match Type Containers, Mixed Containers are also possible, each container can be its own business with duplicate franchise merchandise shipped from overseas,

a. Light Gray Shade Rail Car with or without Detachable Wheel Carriages as shown in FIGS. 1 through 13, b. Medium Gray Shade Semi-Trailer with or without Detachable Wheel Carriages as shown in FIGS. 1 through 13, c. Dark Gray Shade Cargo Containers as shown in FIGS. 1 through 13, d. Metal Storage Racks as Shown in FIG. 21 Item F and FIG. 26 or Regular CBS Construction Storage Units and Container Rows Right Side of Drawings Typical Each Drawing FIGS. 20 through 25, e. Fence Surrounding Entire Yard with Traffic Opening and Sliding Gate, g. Air Freighters or Commercial Cargo Passenger Airliners, f. Combined Storage Trucking and Air Freight Transfer Yard, h. Rail Cars, Semi-Trailers, Cargo Containers, or Reusable Containers and Distribution and Staging Warehouse, as shown in FIGS. 1 through 47 of this patent

FIG. 21 Storage or Self Storage and Transportation Container Yard, Wholesale/Retail or Storage Rental/Leasing or Shipping Facilities, a. Rail Cars on Tracks as shown in FIGS. 1 through 13, b. Multiple Rail Tracks converting existing Rail Passenger Facilities to Storage Facilities or New Construction Railroad Tracks and Storage Facility, c. Office and Vehicle Garage for Products Distribution, Reusable Container Related or any Commodities Related, Flea Market or Individual Retail Business, d. Residential or Commercial Used Containers Collection Truck, e. Used Containers or Sub-Containers Transportation Rail or Semi-Trailer, f. Elevated Steel Storage Racks with Roof as shown in FIGS. 26 and 28, in addition to small containers, boats, and cars, shown in FIG. 26, larger versions of these racks will be capable of holding all containers shown in FIGS. 1 through 13, g. Office and Garage for Reusable Container Facilities and/or other Storage Yard Related Businesses and Facilities

FIG. 22 Single Rail Siding Track for Forklift Storage Yard

FIG. 23 a. Multiple Storage Yards Close Proximity with Access Roads Private or Public to Both between them, One being Private, One being Restricted

FIG. 24 a. Cargo or Container Ship, Self or Dock Loading or Unloading, Serving a Railroad Storage Facilities with Storage, Site Built or Rack Storage and with Forklift able Storage Containers Interchangeable

FIG. 25 a. Storage Yard for Shipping, Trucking, and Rail, Interconnection with Forklift able Storage Containers Interchangeable with or without Site Built or Rack Storage, b. Interconnection of Air, Rail, Trucking, and Shipping

FIG. 26 Storage Rack System, Single or Double Wide, in Various Sizes used in conjunction with FIGS. 1 through 25 and 28 through 47

FIG. 27 Semi Tractor Trailer Enclosed or Flatbed Trailer (Not Shown) with Palettes containing Multiple Partitioned Slots for Returnable Skids and Fold-Down Sub-Containers, Wood, Fiberglass, or Metal Construction, a. 2′×2′×2′ or 4′ Fold-Down Wire Mesh or Sheet Metal Sub-Containers for Palette Based Fold-Down Shelving System, b. 1′×1′×2′ or 4′ Fold-Down Wire Mesh or Sheet Metal Sub-Containers for Palette Based Fold-Down Shelving System, c. 4′×4′ or 2′×4′ Fold-Down Wire Mesh or Sheet Metal Sub-Containers for Palette Based Fold-Down Shelving System, d. 4′×4′ Palette, PVC, Aluminum, Galvanized or Stainless Steel, e. Rear View Semi-Trailer or Rail Car with Rolling Locking Sectional Doors as shown in Figure containing Items h and I and in FIG. 1 Item fin a 42′ Long Semi Tractor Trailer for Storage and Return of Palettes made of Welded Wire and Sheet Metal and Fold-Down Sub-Containers, Stored On-Site at Store Locations or Towed between Store Sites for Individual Pickups until Full then Return to Food Wholesalers and Packaging Plants, f. One Piece Permanently Assembled Palette for Fold-Up Storage Shelving, Containers, and Sub-Containers, Unit 8′9″ H×8′6″ W×8′4″ L with attached Slotted Shelving for Deposit/Returnable or Company Owned Palettes and Fold-Down Sub-Containers, g. Center Divider for Single Approx. Depth 4′×8′×8′ Return Palette, Container, and Shelving Units, also Each Rolling Door Unit will be divided from the Next Unit, h. Side View Rolling Sectional Doors as shown in End View of Item e, i. Side View of Palette, Container, and Shelving Racks, j. Side View Miscellaneous 4′×4′×4′ Containers Full of Products for Delivery to Staging Warehouse, k. Assembled Sub-Container Shelving Unit or Stacked Sealed Goods Sub-Containers. Shelving Unit Sections Paletted constructed of Galvanized or Stainless Sheet Steels, Welded Wires, or Plastics, with Sub-Containers in Place as shown in FIGS. 23 and 24 in the Non-Provisional patent application Ser. No. 12/617,068

FIG. 28 Front View of Palette Racks located at a Product Staging Warehouse or Fenced Yard, Item 1 (4′×4′) Metal or Plastic Covered Container Incoming Full or Partial Load from Manufacturer's Trucks or Picked Up at Manufacturer's Location Consignment or Paid-in-Full, Item 2 (2′×4′×4′) Covered Containers, Side by Side, Metal or Plastic, Item 3 (2′×2′×4′) Covered in Wire Mesh Containers, Item 4 (4′×4′×4′) Covered Container, Metal or Plastic, Item 5 (1′×1′×1′, 2′, or 4′) Boxes or Sheet Metal Containers, Item 6 (4′×4′×4′) Wire Mesh Container, Item 7 (2′×4′×4′) Containers Steel or Cardboard

FIG. 29 Warehouse Re-assemble (4′×4′×4′) Palette of Mixed Products for Truck Route Distribution to Individual or Multiple Wholesalers or Retailers

FIG. 30 (2′×2′) Quarter Palette Assembled Delivery Package

FIG. 31 (2′×4′×4′) Container, Metal or Plastic, with Dividers Installed shown Full of 32 Same Type Product Packages

FIG. 32 (2′×4′×4′) Container with Divider Top and Non-Divider Bottom

FIG. 33 (4′×4′×4′) Container Divided into Various Size Plastic or Metal Sub-Containers including Four 1′×1′×2′ or 4′ and 2′×2′×1′, 2′, 3′, or 4′, and 1′×2′×1′, 2′, 3′, or 4′, Bottom Right Quarter filled with Loose Fill Divided Products

FIG. 34 (2′×4′×4′) Container with Dividers (2′×1′×1′, 2′, 3′, or 4′) for Loose Products. Also in Various Sizes for Various Sized Containers

FIG. 35 Deposit Type Returnable Container Dividers with or without Half Deep Cut-Outs as shown as Item 8

FIG. 36 Used Container Sorting Bin for Durable Metal and Microwavable Reusable Containers such as those used in Frozen and Prepared Foods as shown in this Figure and used in conjunction with FIGS. 20 through 47

FIG. 37 Computer System for Order Receiving, Processing, Money Collection, Freight Shipping Charges, Efficient Shipping and Delivery Coordination, Product Lists, Quantities, Delivery Dates for Deposit Collection and Refunding Credit Card Accounts in conjunction with Credit Card Company Records and/or Grocery Store Receipt Records

FIG. 38 Staging Sub-Warehouse with no Sterilizing Equipment just Sub-Container Sorting and Warehousing New and Used Containers

FIG. 39 Customer Warehouse

FIG. 40 Customer Retail Store

FIG. 41 Customer Grocery Store with Credit Card Terminal and Cash Register Program to Charge Container Deposits and Charge Container Handling Fees, Also Barcodes Stickers on Label will enter Information on the Customer's Account and Receipt containing the Individual's Name owning the Deposit or Traceable Transaction Number that will be forwarded the Deposits Holding Company

FIG. 42 Main Staging Warehouse with Machinery for Container Sorting and Washing Facilities, Goods and Returnable Container Storage

FIG. 43 Regional Deposit Container Warehouse for Manufactured Products Full Shelf Palette and Built-Up Sub-Container Consignment and Cash Sales also Palettes and for Sub-Container Mixing for Individual Route Deliveries, Also Container Washing, Sterilizing, and Sealing, Processes and Subsequent Sterilized Tag Sealed Sales of Deposit Containers to Business Manufacturers, also the Delivery of Newly Re-Filled Product Containers from Route Trucks, Also the Collection of Used Deposit Containers from both Store and Warehouse and Pickup of Used Containers from Businesses and Residences

FIG. 44 Customer Residence or Business with Returnable Container Bin at Each Individual Customer Location, Item 2 Container Lid Wide Open Position, Item 3 Spring Loaded Door for Models involving FIG. 47 and Opening Lid Model for Containers associated with FIG. 39, Item 4 Rolling Wheels for Ease of Movement

FIG. 45 Interstate Container Hauling Semi-Trailer Rail Car or Overseas Shipping Cargo Container

FIG. 46 Consumer and Commercial Route Truck with Various Size Containers Permanently Fixed with Removable Bins with Full and Half Height Opening Doors for Each Compartment with Spring Loading Closing Door at the Top as shown in FIG. 47 Item 1

FIG. 47 Consumer and Commercial Route Truck with Removable Individual Residence or Business Deposit Container Bins filled with Deposit Containers with a Min. Number Required for Truck Pickup, Item 1 Residential or Business Individual Containers Loaded on a Pickup Vehicle. Also shown in FIG. 44 Items 2, 3, and 4, Various Sizes and these units are Returnable Deposit Containers

### PURPOSE AND USEFULNESS

The three new rail cars will rolling door side access will help to interconnect small load deliveries to form a worldwide network for such in demand uses “just in time” factory deliveries and will speed coordination of rail, air, trucking, and shipping, and reduce the cost of present non-divided non-filled containers to individual businesses and transportation companies. This will also reduce loading and unloading times due to easier access to individual small containers. The new businesses generated by these improved business methods will cause the complete interconnection nation wide and worldwide of rail, air, trucking, and shipping.

The new system components will produce energy cost reduction in several ways by allowing stacked storage of container and framed components instead of having to keep rail cars on the tracks and hauling them from one location to the other, empty, also when no return load is available after a delivery, multiple cars can be stacked on one assembly and returned to the next point of usage.

The new doored storage cars will allow for economical point-to-point transportation so that customers can ship their storage containers to new locations without reloading the contents. Also, it will be unnecessary to remove the contents of a car or trailer to get at shipment stored at the rear of the standard type semi-trailer, cargo containers, and two doored rail cars. The new forklift holes allow easy placement and construction of the new cars. The new pin and hole attachment system will prevent shifting stacked containers from being affected by winds. The new storage and transportation yard configurations will allow economical overhead new business establishment options resulting in lower consumer cost for goods and services. The new interconnection of rail, road, ship, and air, freight will produce efficient transfer and storage of containers and cars.

The new system will allow stacked indoor storage of components to avoid weathering corrosion elements during times of non-usage.

Existing cars and containers that are corroded or worn out or too heavy to be cost efficiently used can be converted into permanently fixed storage yard retro fitted divided units with rolling or knob doors.

The new improved business methods for air, rail, shipping, and freight, storage and flea markets will solidify and reduce costs of shipping and consumer costs through an improved system of wholesale/retail transportation coupled with lower costs flea market purchasing power for those individuals below the poverty line.

The new container system will create economic stimulus and jobs by creating unsatisfied consumer demand in the fields of product manufacture involved.

The new warehouse and container system will reduce transportation cost by more efficient truck capacity usage and fewer trucks on the road resulting in less gasoline consumption, labor cost, new and truck purchases, thereby reducing consumer product cost.

The new system will reduce land fill space depletion and the necessity of constructing landfills and/or trash incinerators.

Garbage collection weekly pickups may be stretch to monthly pickups thereby saving tax payers, cost of employee hiring, truck purchasing and maintenance.

The new system will eliminate messy and expensive recycling of plastics, metals, cardboard, and glass.

The reduction in paper related products will reduce the necessity of cutting trees and damages to forest ecosystems, animal life, global warming, drought, and global toxic air.

Container Cost Reduction: The cost of the use of recycled containers is less than the cost of manufacturing new containers due to the durability of the new containers and minimal cost of deposit charging and refunding resulting in lower long term cost to consumers.

The oils and toxic liquids deposit and refund program will eliminate potentially environmentally damaging toxic waste products from becoming illegally dumped because potentially dumpers will be dumping their own money that could be received from their deposit refund.

The new grocery, retail, staging warehouse, and originating manufacturer, system will reduce labor cost or shelf stocking of individual items by dealing in full container and sub-container quantities and products.

The new system will create jobs in container washing and handling fields and equipment manufacturing.

The new system will eliminate trash dumping, by giving a considerable financial reward to those who cleanup the irresponsibility of others. Also, roadside litter, underwater littering, and floating debris will be greatly reduced if the deposits are set high enough.

### REFERENCES

The following patents contain drawings and text either included in this non-provisional patent application or used in connection with components described in this patent application.
Provisional Patent Application 61/102,474 Container System Cubicle Standardized including Shelving Containers, Sub-Containers, and Cart Systems, for Grocery, Retail, Warehouse, and Industrial
Non-Provisional patent application Ser. No. 12/572,593 Container, Sub-Container, Shelving, Reusable Shopping Bags and Cart System Cubicle Standardized Sizes Deposit/Returnable, for Retail, Warehouse, and Industrial, and Efficient Distribution and Trucking Method
Provisional Patent Application 61/113,733 Sheds and Storage Enclosures, Racks, and Cages, for Rental, Retail, Warehouse, and Distribution Systems, Associated Transportation and Franchised Business Systems
Non-Provisional patent application Ser. No. 12/617,068 Sheds and Storage Enclosures, Racks, and Cages, for Rental, Retail, Warehouse, and Distribution Systems, Associated Transportation and Franchised Business Systems
Provisional Patent Application 61/148,135 Structural Building Materials Improved System for Residential, Light Commercial and Prefabricated Sheds, Concrete, OSB, or a Combination, and Rolling Door Side Access Semi-Trailer, Rail Car, and Overseas Shipping Container, Systems, Business Methods for Air, Rail, Trucking, Ship, Freight, Storage, and Flea Market
Provisional Patent Application 61/157,328 Building Construction System Factory Built Semi Trucked Prefabricated Pre-cast Concrete Composite or Improved OSB Composition, 9 ft. Wide by 48 ft. Long Maximum Panels for Crane Quick Erect also Asphalt and Concrete Composite Roofing Materials (Rolls and Sections) for Residential and Small Commercial Construction
Provisional Patent Application 61/243,213 Prefabricated Building Construction System additions including Gantry Crane Mounted on a Truck, Rail Car, or Semi Trailer, with Telescoping Mast and Boom, Elevating Boom, and Hydraulic Stabilizers and Multiple Ganged Molds for Multiple Concrete Products and Manufactured Housing Concrete Composite Fully Assembled and Pumice Concrete Composite Mixtures and Usages

What is claimed is:

1. Claimed is the invention of storage transportation yards, containers, and equipment, comprised of the following;
(a) Multiple Mobile Storage and Transportation Units Commercial as shown in FIGS. 1 through 8
(b) Rail Car Multiple Compartment Storage and Transportation Units as shown in FIGS. 1 through 8
(c) Cargo Container Multiple Compartment Storage and Transportation Units as shown in FIGS. 1 through 8
(d) Lightweight aluminum components in the construction of storage and transportation units and subunits as shown in FIGS. 1 through 19 and FIGS. 26 through 47
(e) Metal lightening in the construction of these new storage and transportation units and subunits as described in the provisional patent application 61/107,096 “Metal Lightening Structural and Stock”, for all units in FIGS. 1 through 19 and FIGS. 26 through 47
(f) The exclusive right to use these new containers contained herein and exclude all other types of containers manufactured by other companies from the new types of facilities as shown in FIGS. 1 through 19
(g) Multi-transportation junction yards for storage, retail/wholesale, and service related businesses, usages, using singular and multiple, railroad track with trucking, ships, and air, for storage, transfer, and business operations, permanent and temporary as shown in FIGS. 20 through 25
(h) The close proximity of multiple rail and civilian new or existing storage yards making transfers quick and easy of received rail goods while maintaining security and non-access of the public to the rail yard as shown in FIGS. 20 through 25
(i) The interconnection of rail and shipping in improved close proximity to facilitate quick and easy transfers for new or existing small container oriented storage facilities as shown in FIGS. 20 through 47
(j) The interconnection of these methods of transportation, rail and shipping, in close proximity of public storage facilities for improved security and the low cost easy transfer from storage yards as shown in FIGS. 20 through 25
(k) The usage of storage racks in conjunction with storage yards as shown in FIGS. 26 and 28 and FIG. 21. These racks may be used either in conjunction with existing CBS one story storage units or without as shown in FIG. 21
(l) The usage of storage racks for the purpose of boat, automobile, and RV storage as shown in FIG. 26
(m) The usage of solid and caged protective containers for the internal storage of boat, cars, and recreational vehicles in order to prevent damage and vandalism during transportation or storage as shown in FIG. 26
(n) The exclusive right of manufacturing usage licensing and a percentage of profits from their improved efficiency of these new or existing containers in conjunction with shipping by existing rail, ocean shipping, and trucking, regardless of federalization or municipal of any system contained herein as shown and described for FIGS. 1 through 47
(o) The staging warehouse for full or partial factory loaded shelving containers and sorted and resorted palette delivery routes containing goods for grocery, warehouse, retail/wholesale service related, etc. shown in FIGS. 28 through 35, also deposit dividers in various sizes, drop-in type, constructed of solid plastic or plastic coated cardboard for retail, wholesale, or grocery shown in FIG. 28 and FIGS. 28 through 35, also the concept of reduced vehicle maintenance cost and fuel energy savings and man labor hours associated with the improved efficiency staging warehouse with or without returnable deposit container facilities
(p) The new and used goods consignment warehouse and interconnected internet ordering as shown in FIGS. 38 through 43
(q) The right to design and manufacture sorting and washing equipment for reusable system containers as described for FIGS. 38 through 47 and FIG. 21

2. Claimed is the invention of new and retrofitted, single and multiple compartment, fixed and teardown, construction of storage and transportation units, in cubicle and standardized sizes, for rail, ship, road, and air. The units are described as follows;
(a) Multi-sized divided compartment side facing rolling door or knob door, or combination, units (see FIGS. 1 through 8), also forklift holes as shown in FIGS. 1 through 15, also hook lift holes as shown in FIGS. 9 through 19 for use with all railroad, semi-tractor trailer, ship, new and retrofitted units shown in this patent, also permanently attached or bolted removable forklift rectangular tube lift holes
(b) Standardized sizes of 8′, 10′, and 12′, wide rolling door storage and transportation subunits shown in FIG. 8, FIG. 5 item A, and FIG. 1 item A, also single and double sided doors storage and transportation subunits shown in FIG. 2 items A and B, also 4′6″ wide by full width storage and transportation subunits, also new construction interchangeable carriage standardized storage and transportation full and subunits in various sizes as shown in FIGS. 1 through 11, also 4′6″ by 4′6″ sized rolling door subunits and 4′6″ by 9′ by half width and full width subunits shown in FIG. 1 item A and FIG. 2 item B, also 4′6″ by 4′6″ sized hinged door subunits and 4′6″ by 9′ by half width and full width subunits as shown in FIG. 1 items B and C and FIG. 2 item B and FIG. 3 items A and B and FIG. 4 and FIG. 5 items B and C and FIG. 7, also full units of 4′6″ by 4′6″ double height rolling door subunits as shown in FIG. 1 item B and FIG. 3 item A and FIG. 4 left side and FIG. 5 item B, also triple height 4′6″ by 4′6″ full units and half units as shown in FIG. 3 item A
(c) Interchangeable road carriage and/or hitch to rail carriage to non-carriage storage and transportation containers as shown in FIGS. 8 through 15, also full length frame interchangeable carriages for use with half units or full loaded flat bed loads as shown in FIGS. 11 through 13, also an intermediate connective top carriage pivoting with four attachment holes for various rail car frames with full interchangeability of all other components described in FIG. 5 and FIGS. 1 through 11, also four, eight, twelve point single or double frame and box attachment method for securing truck carriages or rail carriages to rail cars or rail flat cars or frame and storage and transportation container units as shown in FIG. 10 and FIGS. 14 through 19, also the concept of retrofitting any existing units to any unit shown in FIGS. 1 through 10, also new rollup type doors and interior partitions to except the cargo containers shown in the subunits in FIG. 13 items A, B, and C, and the concept of the usage of the rolling door sections for locked segregated general commercial or house hold residential storage or shipping as shown in FIGS. 1 through 10, also the Convertible Ocean Shipping Container to Railroad Wheeled Freight Car as described in FIGS. 9 through 20
(d) Three additional types of storage and transportation full units or converted existing rail cars or semi trailers including full height heavy duty open box car and half or three quarter height heavy duty open box car and double sided single door covered box storage and transportation full containers as shown in FIG. 6
(e) A Rollup Door, 3 to 8 Doors Each Side, Railroad Boxcar as shown in FIG. 8 item A, also Rollup Door, 3 to 8 Doors Each Side, Semi-Trailer as shown in FIG. 8 item B, also Rollup Door, 3 to 8 Doors Each Side, Overseas Shipping Container as shown in FIG. 8 item C, also removable four wheel railroad car carriages including axle, coupling, and bolt-in base, assemblies as shown in FIG. 8 item A-1 and FIGS. 9 through 20, also dual sided pass by rolling doors as shown in FIG. 8 item D-1
(f) Sectional compartments, removable and insertable, for railroad, trucking, and ocean cargo, containers as shown in FIG. 8 item D-2
(g) Center divider cargo containers with insertable and removable panels for dividing railroad, trucking, and ocean cargo, containers as shown in FIG. 8 item D-3
(h) Conversion of existing rail cars and semi-trailers into rolling door or knob door multiple unit storage and transportation units for permanent storage yard setup and use
(i) Retrofit forklift tubes welded in place below existing frame for all new and existing rail cars, semi-trailers, and ship containers as shown in FIG. 6 items A and C
(j) New construction of framed containers with forklift holes sitting on new and retrofitted main frame with built-in forklift holes as shown in FIG. 6 item B for all new and existing rail cars, semi-trailers, and ship containers
(k) New breakdown type containers, frames, carriages, as shown in FIGS. 9 through 19, also new pin and cross bolt container frame and carriage assemblies as shown in FIGS. 9 through 19, also breakdown component stacking using square tube hole insertion bars and cross bracing units as shown in FIG. 12 item B and shown in FIGS. 11 through 13, also the concept of stacked quick secured frames and carriages

3. Claimed is the invention of interconnected dependent franchised businesses and transportation systems for economical sales methods of new goods delivery and collection of reusable containers, including;
(a) Various sheds and containers of different standardized sizes constructed and designed to fit inside of the new rolling door cargo containers as shown in the four open door examples in FIG. 27 and the right to only accept containers manufactured by us in these new containers as described for FIG. 27 and FIG. 26 and FIGS. 28 through 32
(b) A cost and time saving improvement and ease of loading and unloading the new rolling door containers and a time reduction benefit from the use of the containers as opposed to a standard semi-trailer
(c) Storage and transportation full or half units with multiple subunits that are individually mechanically cooled refrigeration and freezer units in all shown usable car configurations as shown in FIG. 7 and FIGS. 1 through 8, also energy saving non-usage of only one side at a time
(d) The concept of half car cooling units for mixed loads refrigerator, or freezer, or air conditioning as shown in FIG. 7 and FIG. 5 items B and C and FIG. 4
(e) Individual unit thermostat controlled insulated storage and transportation units, propane, natural gas, or electric operated as shown in FIG. 7 and FIGS. 1 through 8
(f) Multi-temperature range single unit capable cooling system with triple usage including climate control, refrigeration, and deep freeze as shown in FIG. 7 and FIGS. 1 through 8
(g) Ducted damper individually controlled multiple subunit or entire unit controlled air conditioned, refrigerated, or deep freeze, thermostatically controlled storage and transportation containers as shown in FIG. 7 and FIGS. 1 through 8
(h) Multiple transportation container storage yards containing a mixture of types of storage and transportation containers described in FIGS. 1 through 10 and the improved variety and selection of goods available from combining the transportation methods as described for FIGS. 20 through 25
(i) The interconnection of self storage and rail as described for FIG. 22
(j) The right to control the sale through franchising of all new businesses forming due the existence of this patent and associated with FIGS. 20 through 25, including new airlines, shipping lines, rail lines, and trucking lines, and the right to restrict or deny the usage of any of these described products or concepts to any existing airlines, shipping lines, rail lines, or trucking lines, that refuses to purchase or license the usage rights as described for FIGS. 1 through 47
(k) Cleaning machinery for reusable deposit containers and the right to design and patent the same and the availability of cleaned containers and deposit refund and charging transactions in conjunction with a staging warehouse as described for FIG. 21 and FIGS. 26 through 47
(l) Route pickups from manufacturers commencing at a staging warehouse as described for FIGS. 38 through 43 and FIG. 21
(m) Route pickups and deliveries commencing at a staging warehouse for retail, grocery, wholesale, service, business, stores, etc. with full reused containers and sub-containers containing new products as shown in FIGS. 38 through 43 and FIG. 21
(n) County municipality charges for reduction in cost associated with lessened volumes of waste materials being processed by county contracted waste deposal companies as a method of funding deposit reusable containers
(o) Charging deposits on refrigerators, furniture, building materials, electronics, automobiles, and all other waste stream products unlikely to be profitably recycled based on material values, and that are presently non-deposit items
(p) Retaining these deposits in a secure account for the purpose of recycling these items when that becomes necessary
(q) Refundable container processing companies offering deposit refunds to residences and businesses that have paid deposits
(r) The concept of recyclable material purchases from individual residences and businesses at the time of pickup of their deposit containers and the carrying of weigh scales on the trucks
(s) The concept of non-recyclable materials charging and hauling away in conjunction with individual resident and commercial deposit container pickups
(t) Charging a processing fee to the end user for the purpose of funding franchised businesses associated with deposit containers
(u) Deposit reusable containers for all goods and products presently not deposit packaged
(v) Returnable container cleaning and sterilizing staging warehouse
(w) Seal installed sterilized containers, sub-containers, and shelving containers as a marketable product to sell to businesses for refilling of their products
(x) The usage of the recycling trailers or separate route trucks for new products home, retail, and wholesale, goods delivery and the carrying of multi level sales marketing items and the use of internet for ordering.
(y) The usage of paletted tub type containers 2′×2′ to 8′×8′ for the purpose of transporting used returnable containers such as durable models of the containers presently used in frozen foods, in both microwavable plastic and metal versions, in all sizes and larger in present usage
(z) Railroad, Highway, and Ship, Small Rental Unit Storage and Transportation Businesses as shown in FIGS. 20 through 47
(aa) Business Method of Rental, Sales, and Manufacture, of Multiple Mobile Storage Units for Rail, Highway, and Overseas Cargo Shipping as shown in FIGS. 20 through 47
(bb) Removable Wheeled Mini Storage Units for Temporary or Permanent Self Storage Unit Businesses as shown in FIGS. 20 through 47
(cc) Inter usage of storage and transportation units with standardized cubicle containers and sheds and storage enclosures as shown in FIGS. 1 through 47 of this patent application and reference page of the specifications in this application. The storage and transportation units as described in patent application 61/148,135, the standardized cubicle containers are described in patent application 61/102,474 Container System Cubicle Standardized, FIG. 27a, b, c, and d, FIG. 30a, FIGS. 32a and 32b, and the sheds and storage enclosures are described in the provisional patent application 61/113,733 Sheds and Storage Enclosures, FIG. 1, and FIGS. 7(1) and 7(2), and FIGS. 8 through 22
(dd) Permanent site built storage units used in conjunction with mobile container units to facilitate the transfer of goods from the mobile units as shown in FIG. 20 items a, b, and c, to the permanent storage units shown in FIG. 20 item d for the purpose of freeing empty containers for return to sender or reloading of other materials and the designation of that container as going to a specific location in order to attract customers to fill the recently empty container and the concepts of setting time limits for pickup of goods as shown in FIG. 20
(ee) The usage of storage rack systems for the purpose of creating an improved unit density in storage and transportation our franchised yards as shown in FIG. 26 and FIGS. 28 through 34 in conjunction with storage yards shown in FIG. 21
(ff) The availability of an airport rolling door container loading and unloading facility to facilitate the use of the new rolling door containers in conjunction with air freight and passenger freight commerce. a new method of business in conjunction with new airports including storage and transportation interconnection with air, rail, ships, and trucking, as shown in FIG. 25
